(19) United States
(12) Patent Application Publication
(10) Pub. No.: US 2008/0113875 A1
(43) Pub. Date: May 15, 2008

(54) MOLECULAR DETECTION BY MATRIX FREE DESORPTION IONIZATION MASS SPECTROMETRY

(76) Inventors: Pierre Chaurand, Nashville, TN (US); Jeremy L. Norris, Knoxville, TN (US); Ned A. Porter, Franklin, TN (US); Junhai Yang, Nashville, TN (US); Richard M. Caprioli, Brentwood, TN (US)

Correspondence Address: FULBRIGHT & JAWORSKI L.L.P., 600 CONGRESS AVE., SUITE 2400, AUSTIN, TX, 78701, US

(21) Appl. No.: 11/852,114

(22) Filed: Sep. 7, 2007

Related U.S. Application Data
(60) Provisional application No. 60/825,014, filed on Sep. 8, 2006.

(51) Int. Cl. C40B 30/04

(52) U.S. Cl. 506/9

(57) ABSTRACT

The present invention provides methods for obtaining information of a plurality of target molecules by matrix free LDI MS. Mass tagged complexes for detection of target molecules comprise a target molecule binding domain, and a mass tag separated by a cleavable linker. Methods of the invention may be used for example to analyze the distribution of a multiple target molecules in a complex sample, such as a tissue section.

The present application claims benefit of priority to U.S. Provisional Application Ser. No. 60/825,014, filed Sep. 8, 2006, the entire contents of which are hereby incorporated by reference.

### BACKGROUND OF THE INVENTION

1. Field of the Invention

The present invention relates generally to the fields of molecular biology and biochemistry. More particularly, it relates to the use of mass tag complexes to detect multiple target simultaneously by mass spectrometry.

2. Description of Related Art

Mass spectrometry (MS) provides an attractive technique for high through-put sample analysis. Recent advances in laser-desorption ionization (LDI) MS technology have also enabled methods for detecting the spatial distribution, and to some degree, the relative quantities of target molecules in samples that are analyzed. These methods have potential use in the analysis of biological samples such as tissue sections. Such methods can provide important information on distribution of various molecules and help elucidate mechanisms of pathophysiologic changes. One possible application of such technology is localization of specific messenger RNA (mRNA) and/or protein molecule targets within cells or tissues. In this respect, the most widely used techniques for assessing the cellular and tissue distribution of protein and mRNA are immunohistochemistry and in situ hybridization. In the clinical setting, immunohistochemistry is an established technique in modern oncology, and many diagnoses are based on its findings. Since these techniques are used with sectioned tissues, the spatial and cellular resolution that is present in the whole organ or tumor is maintained. Although this allows a level of cellular resolution that is not possible with methodologies that require cell disruption or homogenization, a major limitation is that the number of targets that can be simultaneously detected is small. Generally, a single target of interest is probed in a tissue section with multiple, adjacent sections being used to detect other targets in parallel assays.

Analysis of such tissue sections by LDI MS would potentially offer significant advantages over the techniques currently used (see U.S. Patent Publication No. 20050196786). However, one problem with using LDI MS for direct analysis of biological samples is that macromolecules typically do not ionize efficiently. This difficulty was initially addressed by incorporating an energy absorbing matrix with the sample. These matrices enable ionization and direct MS analysis of macromolecule (e.g., proteins), though the mechanism by which this occurs is not fully understood (Tanaka et al., 1988). This process, known as matrix-assisted LDI MS (MALDI MS), has come into wide spread use; however, obstacles still remain. For example, the matrix material, while allowing the detection of macromolecules, has proven to be problematic since matrices that are used can interfere with molecules in the sample, and may also decrease the resolution that is attainable in such an analysis.

Recently, several reports have described the use of tag molecules to specifically label a population of proteins to allow direct comparative analysis of two complex protein mixtures (Zhou et al., 2002; Han et al., 2001; Gygi et al., 1999). These tag molecules are identical in chemical structure, but differ in total mass. A “heavy” version of the tag contains deuterium, while the “light” version contains hydrogen, providing a difference in total mass based on the number of deuterium versus hydrogen atoms present. The remaining structure contains a reactive group to facilitate binding to proteins and an affinity tag, such as biotin. Together, these tags are referred to as isotope-coded affinity tags (ICAT). By labeling two complex protein mixtures isolated from two cell states with a heavy and light ICAT tag, respectively, the states can be differentially analyzed. Following labeling, the mixtures are combined, fractionated and analyzed by liquid chromatography-mass spectrometry (LC-MS). The same proteins from each population can be identified, and a relative ratio between the same protein from the different cell states established based on the presence of the heavy or light affinity tag. A variation on this theme was recently described that adopts the ICAT method to the solid phase to increase the efficiency and reproducibility in the automation of the process. A similar isotope tag is coupled to a solid bead by a photo-cleavable linkage, which provides an efficient mechanism for the purification of the captured proteins or peptides followed by photo-cleavage away from the beads and analysis by LC-MS (Zhou et al., 2002).

Mass spectrometry has recently been used to directly analyze complex sample such as tissue sections. However, data from such methods is often difficult to interpret due to the complexity of the sample. For instance, identifying the MS signature for any one target molecule of interest in the context of a complex background signal has proven challenging. Additionally, these methods have proven limited with regard to the spatial resolution that they afford. Thus, there remains a need in the art for improved methods for obtaining information about target molecules in a sample by mass spectrometry. In particular, methods for obtaining accurate information, such as spatial distribution, for target molecules require improvement.

### SUMMARY OF THE INVENTION

Thus, there are provided methods for obtaining information on multiple distinct target molecules. For example, a method according to invention may comprise (a) obtaining a population of mass tagged complexes wherein each of the mass tagged complexes comprises (i) a distinct mass tag that is detectable by mass spectrometry, (ii) a binding domain with specificity for a distinct target molecule, and (iii) a cleavable linker region between the distinct mass tag and the binding domain. According to the method, the population of mass tagged complexes may be contacted with a sample under conditions that allow the binding domain(s) of the mass tagged complexes to interact with the target molecule(s) (b). The linker of the mass tagged complexes may then be cleaved (c) to free the mass tag(s) and the mass tag(s) complexes are detected (d) by matrix-free desorption ionization mass spectrometry (MS). The term matrix, as used herein, refers to an additional material that is mixed with a sample and absorbs energy during the desorption ionization MS. Matrix free MS methods, according to the invention, enable the gathering of very precise information on target molecules such information may be used to generate an image of said molecules in the sample. A variety of desorption ionization MS techniques may be used according to the invention, for instance, desorption electrospray ionization mass spectrometry (DESI MS), secondary ion mass spectrometry (SIMS), inductively coupled plasma mass spectrometry (ICP MS) or laser desorption/ionization mass spectrometry (LDI MS). In some aspects, methods according to invention provide image resolution (i.e., resolution of the spatial location target molecules) of about 100 μm, 50 μm 25 μm, 10 μm, 5 μm or less. For example, methods of the invention may be defined as providing spatial resolution of between about 300 μm and 1 μm, about 100 μm and 0.1 μm, about 25 μm and 0.1 μm, about 10 μm and 1 μm or about 5 μm and 1 μm. As used herein, the term “information” encompasses information on, for example, the identity of a given target and/or spatial or positional information on a target. Information obtained by the methods according to the invention may be both qualitative and quantitative. It is contemplated that a variety of different molecules may be used as mass tags according to the methods of the invention. Thus, mass tagged complexes may have a unique mass tag linked to each unique binding domain. In some cases, a population of mass tagged complexes may comprise one, two, three, four, five, six, or more unique mass tags attached to specific binding domains. Thus, methods of the invention allow simultaneous gathering of information regarding one, two, three, four, five, six, or more distinct target molecules.

Mass tags for use according to the invention may comprise a variety of molecules of known mass. In some particular cases, a mass tag of the invention may be a polymer. For example each distinct mass tag can comprise a unique number of polymerized units. In certain specific cases a mass tag may be an amino acid polymer. In certain cases, mass tags according to the invention will be about 3,000 atomic mass units (amu), 2,000 amu, 1,000 amu, 500 amu or less in mass. Furthermore, in certain aspects, mass tags of the invention may comprise positively or negatively charged functional groups or may comprise an intermediate charge species produced during the cleavage process. For instance, a mass tag may comprise a charge carried by a —P⁺R′₃, —N⁺R′₃, amidino or guanadino group.

In certain aspects of the invention, mass tagged complexes may have a binding domain comprised of amino acid or nucleic acid sequences. For example a nucleic acid binding domain may be a RNA or DNA, and in some cases can be a nucleotide sequence composed of 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 nucleotides or any range derivable therein. In some very specific embodiments, an oligonucleotide binding domain may between 8 and 25 nucleotides in length. In some cases, binding domains of mass tagged complexes may also be aptamers that have specificity for specific target molecules. Thus, in certain embodiments, nucleic acid binding domains may detect target molecules by tertiary structure interactions, while in other embodiments detection of target molecules is by base paring interactions. In yet further embodiments, the mass tagged complex binding domain can be an amino acid sequence. For example, such a domain may comprise an antibody or fragment thereof. In certain specific cases, these binding domains may comprise IgG, IgA, IgE, F(ab) or F(ab′)₂ fragments or a single chain antibody domain.

Methods according to the current invention allow the simultaneous detection of a variety of target molecules. For example, target molecules can be a small molecule, RNA, DNA, protein, carbohydrate, or lipid molecule. In some specific examples, the target molecule may be a membrane protein. In certain specific embodiments, target molecules are macromolecules, for example, molecules larger than about 500, 1000, 2,000, or 3,000 Daltons in mass. Target molecules can be detected in variety of samples comprising both liquid and solid phase samples. In certain cases, it may be preferable that a liquid sample be embedded in solid substrate, such as a gel, prior to analysis. Thus, samples analysis by methods of the invention include but are not limited to, cell lysates, tissue cross-sections or body fluids.

In certain aspects of the invention, LDI-MS according to the current invention may be performed by any of a variety of methods that are well known to those in the art. In some specific cases lasers that emit a beam in the ultra-violet wave length (UV lasers) may be employed. In some very specific embodiments, a laser that emits a beam with a wave length of between about 300 and 400 nm (e.g., about 337, 349 or 355 nm) may be used according to the invention. For example, a N₂ laser may be used in such methods.

Mass tagged complexes according the invention also comprise a linker domain that may be cleaved. For example, chemically cleavable linkers, enzyme cleavable linkers and/or linkers that are cleaved in a predictable manner under controlled energetic excitation. For example, a linker may be cleaved by electromagnetic energy (e.g., laser light) or by particle bombardment. Linkers for use according to the invention include but are not limited to aryl azides, carbodiimides, hydrazines, hydroxymethyl phosphines, imidoesters, isocyanates, carbonyls, maleimides, NHS-esters, PFP-esters, psoralens, pyridyl disulfides, vinyl sulfones, benzoin (ester) derivatives, arysulfonamide derivatives, thiopixyl derivatives, coumaryl derivatives, nitrobenzyl derivatives, α,α-dimethyl-3,5 dimethyoxybenzyloxycarbonyl derivatives, phenacyl derivatives, arylmethyl derivatives, vinylsilane derivatives or cinnamic acid derivatives. In certain aspects, a linker may be defined as a photo-cleavable linker, such as a benzoin (ester) derivative, arysulfonamide derivative, thiopixyl derivative, coumaryl derivative, nitrobenzyl derivative, α,α-dimethyl-3,5 dimethyoxybenzyloxycarbonyl derivative, phenacyl derivative, arylmethyl derivative, vinylsilane derivative or cinnamic acid derivative. For example, a photo-cleavable linker may be a cinnamic acid based linker.

In certain cases, LDI-MS is used for methods of the invention. In these cases, it may be preferable that a mass tagged complex comprises a linker that is cleaved by the electromagnetic radiation from the laser. Thus, in some embodiments, a method according to the invention comprises (a) obtaining a population of mass tagged complexes wherein each of the mass tagged complexes comprises (i) a distinct mass tag that is detectable by mass spectrometry, (ii) a binding domain with a specificity for a distinct target molecule, and (iii) a photo-cleavable linker region between the distinct mass tag and the binding domain. The population of mass tagged complexes may be contacted with a sample under conditions that allow the binding domain(s) of the mass tagged complexes to interact with the target molecule(s) (b). The mass tag(s) complexes are detected by matrix-free laser desorption ionization mass spectrometry (LDI-MS), wherein the laser is capable of cleaving the photo-cleavable linker of the mass tag(s).

In some further specific cases, SIMS is used for methods of the invention. In these cases, it my be preferable that a mass tagged complex comprises a linker that is cleaved by mass bombardment, as provided by SIMS. Thus, in some instances, a method according to the invention comprises (a) obtaining a population of mass tagged complexes wherein each of the mass tagged complexes comprises (i) a distinct mass tag that is detectable by mass spectrometry, (ii) a binding domain with a specificity for a distinct target molecule, and (iii) a energy-cleavable linker region between the distinct mass tag and the binding domain. The population of mass tagged complexes may be contacted with a sample under conditions that allow the binding domain(s) of the mass tagged complexes to interact with the target molecule(s) (b). The mass tag(s) complexes may be detected by matrix-free secondary ion mass spectrometry (SIMS), wherein the ion bombardment is capable of cleaving the energy-cleavable linker of the mass tag(s) in predictable manner.

In still further cases, it is contemplated that two or more mass tags and linkers may be conjugated to a binding domain according to the invention. Thus, in some embodiments, a mass tagged complex of the invention comprises a binding domain with specificity for a distinct target molecule and plurality of distinct mass tags wherein each mass tag is linked to the binding domain by a cleavable linker. For example a binding domain may comprise a dendrimer (e.g., see Patri et al., 2004) that is linked via cleavable linker to a plurality of distinct mass tags. Such an arrangement allows increased sensitivity, thereby enabling the detection of target molecules with very low abundance.

Embodiments discussed in the context of a method according to the invention may be employed with respect to any other method described herein. Thus, an embodiment pertaining to one method may be applied to other methods of the invention as well.

As used herein the specification, “a” or “an” may mean one or more. As used herein in the claim(s), when used in conjunction with the word “comprising”, the words “a” or “an” may mean one or more than one. As used herein “another” may mean at least a second or more.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1: Example protocol for detection methods of the invention. 1, method for obtaining a mass tagged complex comprising a mass tag (represented by the diamond), a binding domain (in this case an antibody) and cleavable linker. 2, the tagged complex is allowed to bind to the target molecule. 3, the linker is cleaved (in this case via electromagnetic radiation) and the mass tags detected via MS. 4, a method for simultaneously detecting a plurality of target molecules with mass tagged complexes comprising distinct mass tags (shaded diamonds).

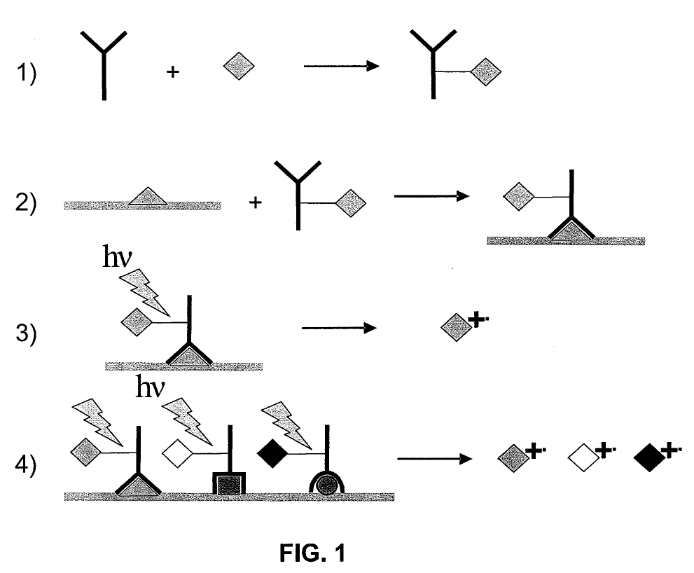

FIG. 2: An example of a synthesis strategy for a cinnamic acid based linker.

FIG. 3: An example method for labeling polypeptide binding domains (e.g., antibodies) with mass tagged cinnamic acid based linkers.

FIGS. 4A-B: MALDI-TOF analysis of antibodies that are unmodified (FIG. 4A) or tagged with the indicated mass tag and cinnamic acid based linker (FIG. 4B).

FIG. 5: A schematic representation of cinnamic acid linker cleavage by electromagnetic radiation.

FIG. 6: Antibodies tagged with the indicated mass tag and cinnamic acid based linker are immobilized on a nitrocellulose membrane and detected by LDI MS.

FIG. 7: A schematic showing how a mass tagged complex may be bound to a specific target molecule. The presence of the target molecule is then detected by LDI MS detection of the mass tag.

FIG. 8: Methods of the invention may be used to determine the location of target molecule. A mass tagged complex is bound to a target molecule (IgG) at a specific location on a nitrocellulose membrane. The location of the target molecule is then determined by detecting the mass tag via LDI MS. The x/y axis indicates location, z axis indicated signal intensity corresponding to the mass tag.

FIG. 9: Methods of the invention may be used to determine the location and quantity a target molecule. Target molecules were immunized at different locations and in different amounts on a nitrocellulose membrane and contacted with a mass tagged complex. Target molecule location and quantity are detected via LDI MS. The x/y axis represent location, z axis indicates signal intensity for the mass tag corresponding to target molecule quantity.

FIG. 10: An example method for mass tagging of dendrimers.

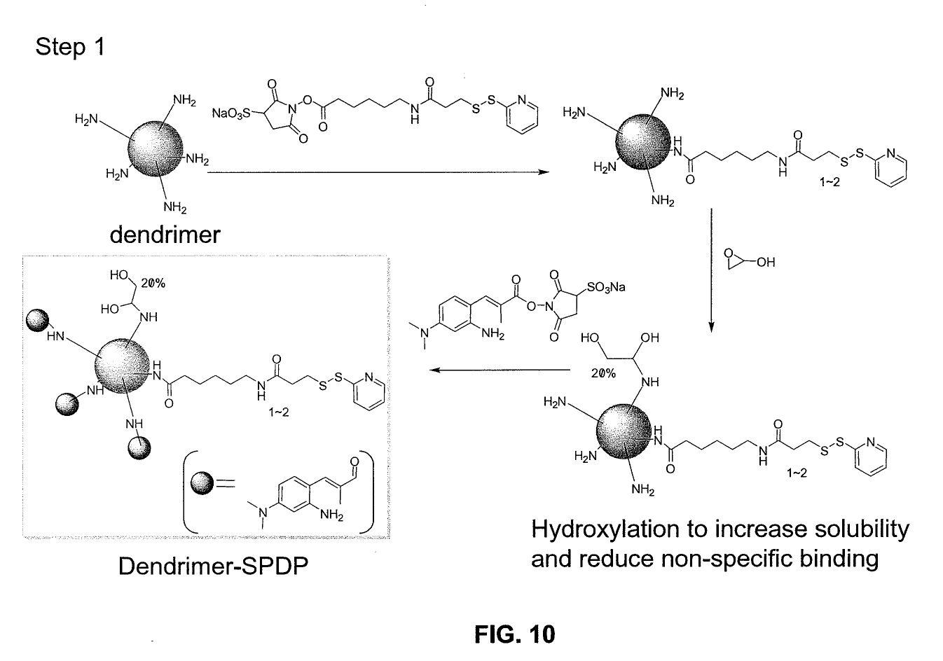

FIG. 11: An example method for labeling antibodies with mass tagged dendrimers.

### DESCRIPTION OF ILLUSTRATIVE EMBODIMENTS

Mass spectrometry has proven a very useful tool in detailed sample analysis; thus MS analyses are now being used to examine more and more complex samples. Ultimately, MS could be used for detailed studies of biological samples, such as tissue sections, tumor biopsies or body fluids. However, the complexity of such sample has proven problematic since information about any particular target molecule must be separated from a complex MS background. To address this issue, target molecules may be bound to mass tagged complexes prior to analysis. However, for detailed analyses, it would be highly advantageous to obtain information about target molecules with highly accurate spatial resolution. The methods described herein provide such techniques.

Methods according to the invention allow for the simultaneous detection of a variety of target molecules in a sample by MS. These methods can provide information on the spatial position of the target molecules in the sample, and offer significant improvements over methods of target detection via MALDI MS (Stoecki et al., 2001). In particular, detection of macromolecules by MS typically requires the deposition of a laser adsorption matrix (or, in some cases, crystallization of a sample in such a matrix) that enables the ionization of molecules greater than about 1,000-3,000 Daltons in mass (Tanaka et al., 1988). However, such matrices also introduce additional complexities into analyses. For example, in many cases a matrix must be deposited onto a sample separately, such deposition must be carefully controlled in order to preserve the spatial integrity of the sample. Additionally, matrices have the potential to chemically and/or structurally modify target molecules in a sample and to interfere with the binding of target molecules by mass-tagged complexes, in the case of indirect target detection. Finally, inclusion of a deposition matrix in a sample often lowers the resolution of MS.

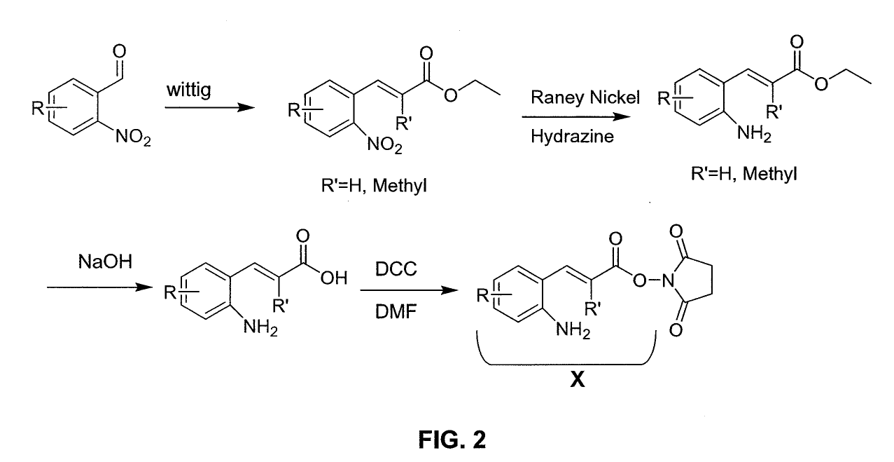

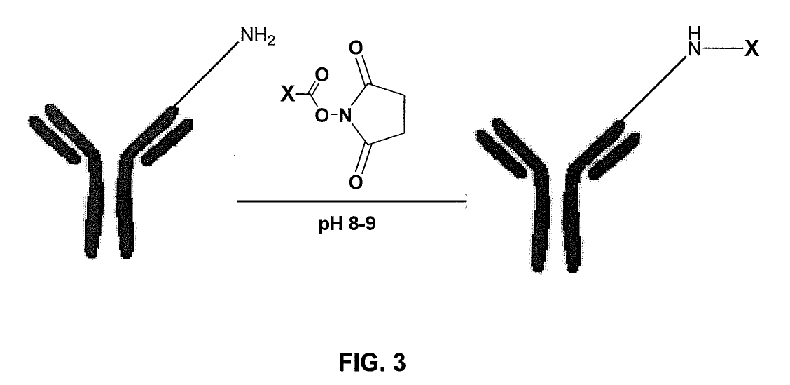

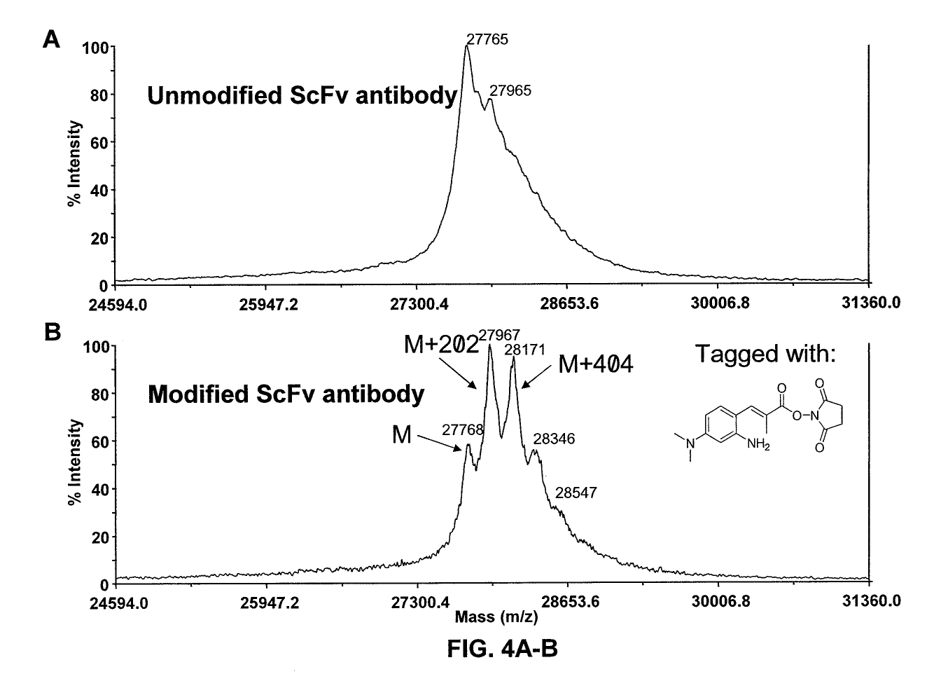

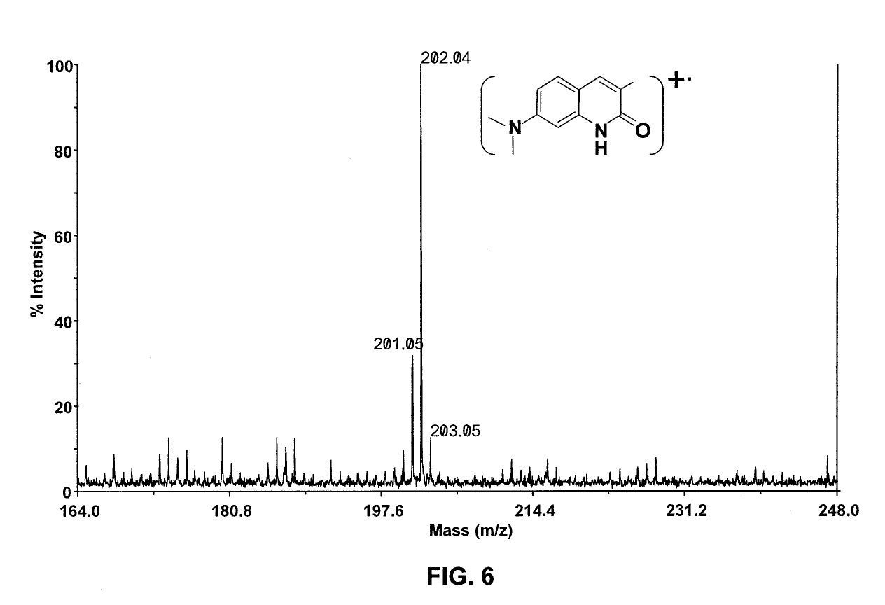

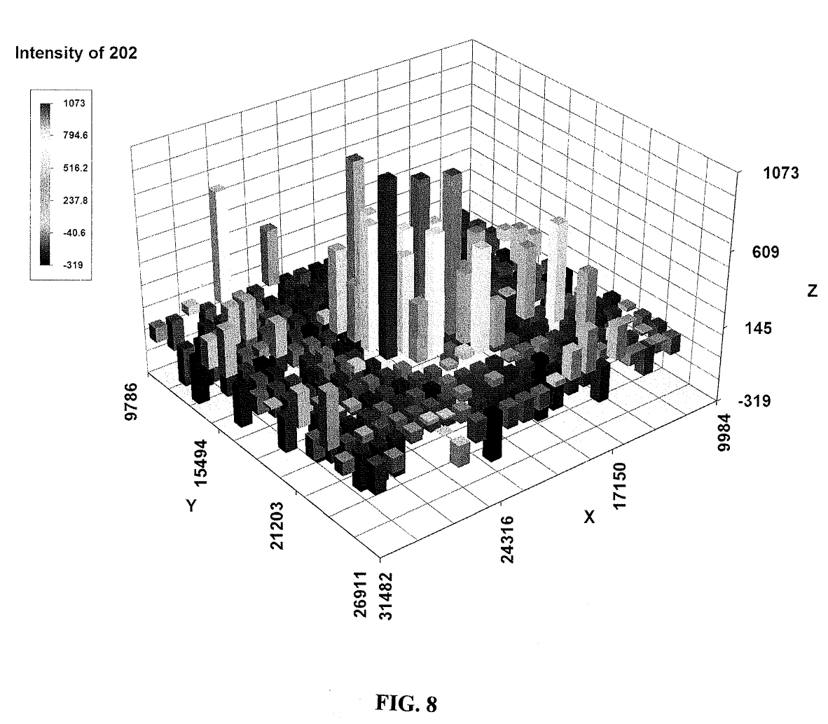

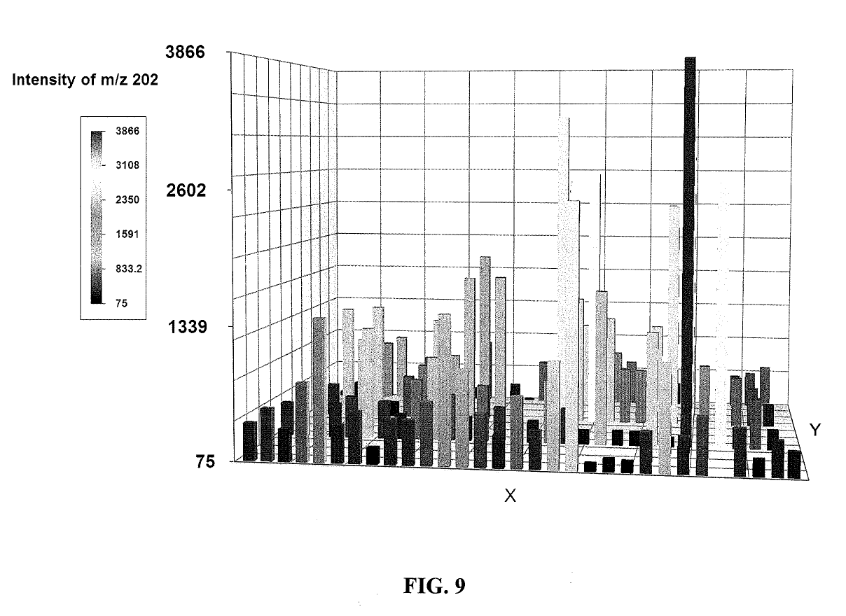

Methods of the invention enable analysis of complex samples using mass tagged target binding complexes and matrix-free MS. Each complex comprises a target binding domain linked to a mass tag, wherein the linkage is cleavable in predictable manner. Since, mass tags used in these methods are relatively small and are of a predictable size after cleavage, their presence and location can be determined by MS without the need for a deposition matrix. Studies described herein demonstrate the feasibility of these new analysis methods. For example, antibodies may be mass tagged using a predictably cleavable linker such as cinnamic acid linker (FIGS. 2 and 3). When exposed to electromagnetic radiation at the proper wavelength, the linker is cleaved and the resultant mass tag is readily detectable by matrix-free MS (FIG. 4B). Furthermore, the cleaved mass tag remains detectable even when the complex is used to bind target molecules on a membrane which also comprises a mixture of other proteins (FIG. 6). Importantly, the spatial location of a mass tagged complex can be detected using the techniques of the invention (FIG. 8), and the relative quantity of a target molecule at any particular location can also be determined (FIG. 9). Thus, the methods described herein can be used to localize and quantify target molecules with-in a sample with-out the need for a matrix deposition step, thereby enabling MS detection methods with enhanced resolution.

The methods described herein offer numerous advantages over prior methods for MS analyses. For example, mass tagged complexes may comprise a linker that is cleavable by a particular energy source, such as electromagnetic radiation or particle bombardment. Following cleavage the sample maybe directly analyzed by MS and since cleavage will be induced only in regions that are exposed to the particular energy source resolution; spatial resolution is only limited by the focal diameter that can be achieved by the energy source. Thus, spatial resolution of 10 μm or less can easily be achieved. Furthermore, multiple target binding molecules with distinct mass tags may be analyzed simultaneously to provide spatial and quantitative information on a plurality of targets in a sample. Ultimately, such techniques may be used to simultaneously provide information on hundreds of different molecular targets in a sample thereby enabling high through-put, detailed analyses of complex biological samples, such as tissue sections.

### I. MASS TAG COMPLEXES

A. Nucleic Acid Targets

Using the basic premise of the ICAT technology, described supra, the present invention provides tag mass tag complexes that can be used for in situ hybridization reactions, followed by detection and visualization by Imaging Mass Spectrometry (IMS), using Laser Desorption Ionization Time of Flight Mass Spectrometry (LDI-TOF MS). The mass tag is linked to nucleic acid binding moiety through a cleavable linker. The cleavable linkage is used to separate the specific mass tag away from the remainder of the complex. Since IMS can detect very small mass changes in the tag molecules (as illustrated by the use of deuterium-labeled ICAT tags (Gygi et al., 1999), coupling specific mass tags with different oligonucleotide sequences will allow the simultaneous detection of several mass tags from the same tissue section, which is a tremendous advance compared to standard in situ techniques. It is contemplated that the nucleic acid binding moiety may be a nucleic acid binding protein, an oligonucleotide molecule that hybridized to the target nucleic acid or an aptamer specific for the target nucleic acid.

B. Protein Targets

Using an approach almost identical to that discussed above for nucleic acids, the present invention also provides tag molecules that can be used in situ for the detection and visualization, by LDI-TOF MS, of proteins. Tags are linked to an antibody, a lectin or an aptamer through the cleavable linker. The cleavable linkage is used to separate the specific mass tag away from the target binding domain. Coupling specific mass tags with different antibodies or aptamers will allow the simultaneous detection of several mass tags from the same sample.

C. Lipid and Carbohydrate Targets

The techniques discussed above are also fully applicable to the detection of specific carbohydrate and/or lipid targets. However, in this specific case, target binding domains on the mass-tagged complexes are antibodies or aptamers that are specific for a given target carbohydrate or lipid molecule (such as a phospholipids head group that is exposed to the aqueous environment). Thus, it will be understood that methods according to the invention not only allow the detection of multiple target molecules simultaneously, but also the detection of a variety of different kinds of target molecules simultaneously. Such techniques may have particular application in high resolution co localization studies, for example, samples such as tissue sections.

D. Mass Unit

In some cases mass units for use in the invention may be coumarin compounds such as those described in the examples. Also, coumarin derivatives comprising a fixed charge such as quaternary amine or phosphine may be used as mass tags.

In some embodiments, a diversity of mass tags is provided by the use of short peptides coupled to the target binding agent through a linker. Small peptides are easy to synthesize and have enough structural diversity so that the individual members of a probe library could each have a unique peptide-based MS tag. This would require peptides between four and six amino acids long. Standard solution-phase peptide synthesis will be used for the preparation of the tag with the N-terminus protected as an FMOC and the C-terminus as a benzyl ester. The choice of amino acids for mass tags will be restricted to polar neutral amino acids for nucleic acid targets and binding agents since highly charged amino acids tags may form secondary structure with the probe DNA sequence through ion pairing interactions and thus interfere with hybridization to a target RNA. Using predominately polar amino acid residues will also ensure high water solubility. A six amino acid peptide tag incorporating only 6 standard, neutral, polar amino acids (Ser, Thr, Cys, Asn, Gln, and Tyr) would provide up to 46,656 different tag molecules.

In the case where lower resolution MS instruments are used for the IMS measurements, peptides with different sequences but the same mass may be indistinguishable. A small program has been developed using the software package Mathmatica to generate all unique mass tags possible from a user-defined set of parameters including peptide length, amino acid identity and mass. However, tandem MS-MS instrumentation that is able to distinguish mass tags with the same mass, but different peptide sequences, based on fragmentation in the second MS sector is available in IMS (see Reyzer et al. 2003). Future use of tandem MS is contemplated as the diversity of mass tags useful in LDI-TOF IMS may eventually be exhausted.

E. Cleavage Linkers and Coupling Schemes

Mass tagged complexes according to the invention also comprise a cleavable linkage between a MS detection molecule and a target binding region. A variety of cleavage sites may be employed, including but not limited to energy-cleavable (e.g., photo-cleavable), chemically-cleavable and enzymatically-cleavable sites. However, it will be understood that the cleavage must occur in a predictable manor such that the resultant mass tag has an identifiable signal when analyzed by MS. Another requirement is that the linker must not interfere with the binding of the biological detection molecule through ionic or steric interference. An example type of linker using cinnamic acid moiety is shown in FIG. 3.

The design criteria for a DNA probe with mass spectrometric tags is described below. Hybridization and in some cases aptamer probes may be synthesized by standard solid-phase oligonucleotide synthesis using phosphoramidite reagents. Thus, the reagent for incorporation of the MS tag must be compatible with standard DNA synthesis technology.

Peptide tags, for example, may be utilized for MS detection. Small peptides are easy to synthesize and have enough structural diversity so that the individual members of a probe DNA library could have a unique peptide-based MS tag.

Overview of Oligonucleotide-Peptide Conjugation (OpeC™) Technology. OpeC™ technology allows the convenient conjugation of peptides to oligonucleotides in three steps using three main reagents: an Oligonucleotide Modifying Reagent (OMR); a Peptide Modifying Reagent (PMR); and a Conjugation Reagent. The OpeC™ technology is based on the principle of template-free “native ligation” and was developed by Michael Gait at the Medical Research Council in Cambridge, UK (Patent No. PCT/GB00/03306 and described in Stetsenko, 2000. The OpeC™ technology is now a commercial product of Link Technologies, Lanarkshire, Scotland.

To facilitate the efficient coupling of oligonucleotides to peptides, the basic steps followed in the process are synthesis of oligonucleotides and peptides by standard means followed by the modification of each of the synthesized components by their respective reagent. Following purification, the two components are coupled in a reaction using the third reagent. Specifically, the Oligonucleotide Modifying Reagent is used in the final coupling step in standard phosphoramidite controlled-pore glass solid-support oligonucleotide assembly. A coupling time of 10 minutes on a 1 μmol scale results in an average yield of >97% as measured by HPLC. Conventional deprotection with an aqueous ammonia solution at 55° C. generates the functionalized oligonucleotide in solution, maintaining the S-tert-butylsulfenyl protecting group but removing the Nₐ-Fmoc group. Addition of the OMR results in a 368.45 mass unit increase in the weight of the oligonucleotide.

The Peptide Modifying Reagent is added after the final coupling step of standard Fmoc-based solid-phase peptide assembly, but before removing the peptide from the solid support. Use of a PEG-polystyrene support containing a standard Rink amide linker or PAL linker protects the C-terminus of the peptide from possible interference with native ligation. The modified peptide is released from the solid support as a C-terminal amide. This occurs during side-chain deprotection by treatment with trifluoroacetic acid-phenol-benzylmercaptan-water. Addition of the PMR results in a 206.27 mass unit increase in the weight of the peptide.

Conjugation of the modified oligonucleotide with the modified peptide is based on the “native ligation” of an N-terminal thioester-functionalised peptide to a 5′-cysteinyl oligonucleotide. The conjugation reagent removes the tert-butylsulfenyl protecting groups, using thiophenol and benzyl mercaptan as conjugation enhancers.

Photo-Cleavable Modification Reagents. Because this invention requires the ultimate release of the peptide from the coupled oligonucleotide when exposed to the ionizing laser of the mass spectrometry instrument, a photo-cleavable linker is included during the last step of the oligonucleotide synthesis prior to addition of the OMR. The photo-cleavable linker that was used here was developed by Kenneth Rothschild at Ambergen Inc, Boston, Mass. Described in (Olejnik, 1999). The general design of Ambergen's photo-cleavable (PC) monomers is based on an α-substituted 2-nitrobenzyl group. The photo-reactive group originates from a cyanoethyl phosphoramidite for use in standard automated DNA synthesizers. The PC spacer phosphoramidite, unlike other 5′-terminus PC modifiers, can be used during an intermediate step of oligonucleotide synthesis, a vital component of this technology as it allows the efficient use of the OMR following addition of the cleavable linker. The nature of the conjugation reaction requires that the OMR be in a terminal position, therefore situating the PC spacer between the OMR and the oligonucleotide suits our purpose ideally. Photo-cleavage of the final conjugate results in the oligonucleotide bound to a single phosphate group and the peptide attached to the PMR, the OMR, and a phosphoramidite spacer.

Preparation of Modified Oligonucleotide. Oligonucleotides May be Assembled using the standard 2-cyanoethyl phosphoramidite method on a standard glass support. As mentioned previously, the PC Spacer Phosphoramidite is added to the 5′ end of the last nucleotide during synthesis. After removal of the last dimethoxytrityl group, the OMR is coupled (150 μmol in 1 ml dry acetonitrile to give a 0.15 M solution) to the support-bound oligonucleotide using the extended coupling protocol. Following normal iodine-water oxidation, the support is flushed with 20% piperidine in DMF for 10 min, washed with 10 ml of DMF, 10 ml of acetonitrile, then dried. The oligonucleotide is cleaved from the solid support by treating with 0.5 ml of aqueous ammonia at room temperature for two hours. The product is washed with an additional 0.5 ml of concentrated ammonia then transferred to a screw-capped polypropylene tube and heated for 16 hr at 55° C. This step ensures complete deprotection of the oligonucleotide at the nucleobase and phosphate residues. Following cooling and evaporation, 1 ml of deionized water is added and evaporated to dryness under vacuum.

Preparation of Modified Peptide. The choice of amino acids for the tag will be restricted to polar neutral amino acids. There is concern that highly charged amino acids tag may form secondary structures with the probe DNA sequence through ion pairing interactions, and thus interfere with hybridization to a target RNA. Thus, one will use predominately polar amino acid residues to ensure high water solubility. A large number of natural and unnatural amino acids are available and should provide enough diversity for this encoded tagging of the probe DNA. The peptide tag will have a free N-terminus that will be the charged moiety of the mass spectral detection. In addition, one should be able to readily incorporate a brominated amino acid, such a 3-bromotyrosine which will provide a unique signature in the mass spectrum and thus enhance detection. Alternatively, metal ions may also be incorporated into the chemical structure to eliminate the need for matrix material to facilitate efficient ablation during MS. This would potentially increase resolution and decrease any detection variability introduced by the matrix material.

Synthesis is generally performed on a 0.1 mmol scale using a standard Fmoc protocol and a PAL-PEG-PS solid support. After removing the last Nₐ-Fmoc, the PMR is coupled to the last amino acid of the support bound peptide (using 4.5 equivalents of PMR and 1 equivalent of HOBt in 2 ml DMF) for 4 hr at room temperature. The resin is washed with 5×5 ml DMF, 3×5 ml methanol, 2×5 ml diethyl ether, and dried. The modified peptide is cleaved from the solid support and side-chains deprotected by treating with TFA-benzylmercaptan-phenol-water (90:5:2.5:2.5 v/v/w/v) for 1-6 hrs depending on N^{G}-2,2,4,6,7-pentamethyldihydrobenzofuran-5-sulfonyl (Pbf) arginine content. TFA is removed by flushing the filtrate with a stream of nitrogen. Precipitation is then done with cold (−20° C.) diethyl ether followed by washing three times with diethyl ether and drying under vacuum to remove all traces of TFA. Before use, the modified peptide is purified using any standard peptide purification technique.

Preparation of Oligonucleotide-Peptide Conjugate. The Conjugation Reagent is prepared by dissolving the dry form of the reagent in 3.5 ml 0.1 M ammonium acetate and adding 5 M NaOH to a pH of approximately 7.5. To 1 μmol modified oligonucleotide pellet is added 1 ml of the Conjugation Reagent and incubated at room temperature for 3 hrs. Five molar equivalents of modified peptide with respect to modified oligo is dissolved in 200 μl 0.5 M ammonium bicarbonate and 300 μl HPLC grade acetonitrile. 500 μl of the pre-reduced oligonucleotide solution is added along with 1% v/v thiophenol and 2% v/v benzyl mercaptan to the reaction followed by thorough mixing and incubation at 37° C. for 24 hrs. Thiphenol is removed from the reaction by washing with 5×0.5 ml pentane. Traces of pentane are removed by evaporation under vacuum. The conjugation reaction is further purified using gel purification or gel filtration prior to use in any hybridization reactions.

Using nearly identical procedures used for the hybridization probes, an encoded tag to be covalently linked to antibodies will be developed using an alternative photo-cleavable linker that facilitates coupling to amine groups on the antibody of interest. This linker is available from the same sources described above for the hybridization photo-cleavable linker.

F. Target Binding Agent

1. Nucleic Acids

Certain embodiments of the present invention comprise the preparation and use of a nucleic acid. The term “nucleic acid” is well known in the art. A “nucleic acid” as used herein will generally refer to a molecule (i.e., a strand) of DNA, RNA or a derivative or analog thereof, comprising a nucleobase. A nucleobase includes, for example, a naturally-occurring purine or pyrimidine base found in DNA (e.g., an adenine “A,” a guanine “G,” a thymine “T” or a cytosine “C”) or RNA (e.g., an A, a G, an uracil “U” or a C). The term “nucleic acid” encompasses the terms “oligonucleotide” and “polynucleotide,” each as a subgenus of the term “nucleic acid.” The term “oligonucleotide” refers to a molecule of between about 3 and about 100 nucleobases in length. The term “polynucleotide” refers to at least one molecule of greater than about 100 nucleobases in length.

These definitions generally refer to a single-stranded molecule, but specific embodiments will also encompass an additional strand that is partially, substantially or fully complementary to the single-stranded molecule. Thus, a nucleic acid may encompass a double-stranded molecule that comprises one or more complementary strand(s) or “complement(s)” of a particular sequence comprising a molecule. As used herein, a single stranded nucleic acid may be denoted by the prefix “ss,” and a double stranded nucleic acid by the prefix “ds.”

Nucleobases. As used herein a “nucleobase” refers to a heterocyclic base, such as for example a naturally-occurring nucleobase (i.e., an A, T, G, C or U) found in at least one naturally-occurring nucleic acid (i.e., DNA and RNA), and naturally or non-naturally-occurring derivative(s) and analogs of such a nucleobase. A nucleobase generally can form one or more hydrogen bonds (“anneal” or “hybridize”) with at least one naturally-occurring nucleobase in manner that may substitute for naturally occurring nucleobase pairing (e.g., the hydrogen bonding between A and T, G and C, and A and U).

“Purine” and/or “pyrimidine” nucleobase(s) encompass naturally occurring purine and/or pyrimidine nucleobases and also derivative(s) and analog(s) thereof, including but not limited to, those a purine or pyrimidine substituted by one or more of an alkyl, caboxyalkyl, amino, hydroxyl, halogen (i.e., fluoro, chloro, bromo, or iodo), thiol or alkylthiol moeity. Preferred alkyl (e.g., alkyl, caboxyalkyl, etc.) moieties comprise of from about 1, about 2, about 3, about 4, about 5, to about 6 carbon atoms. Other non-limiting examples of a purine or pyrimidine include a deazapurine, a 2,6-diaminopurine, a 5-fluorouracil, a xanthine, a hypoxanthine, a 8-bromoguanine, a 8-chloroguanine, a bromothymine, a 8-aminoguanine, a 8-hydroxyguanine, a 8-methylguanine, a 8-thioguanine, an azaguanine, a 2-aminopurine, a 5-ethylcytosine, a 5-methylcyosine, a 5-bromouracil, a 5-ethyluracil, a 5-iodouracil, a 5-chlorouracil, a 5-propyluracil, a thiouracil, a 2-methyladenine, a methylthioadenine, a N,N-diemethyladenine, an azaadenines, a 8-bromoadenine, a 8-hydroxyadenine, a 6-hydroxyaminopurine, a 6-thiopurine, a 4-(6-aminohexyl/cytosine), and the like. Table 1, showing non-limiting, purine and pyrimidine derivatives, is provided herein below.

TABLE 1
Purine and Pyrmidine Derivatives or Analogs

| Abbr. | Modified base description |
|---|---|
| ac4c | 4-acetylcytidine |
| Chm5u | 5-(carboxyhydroxylmethyl) uridine |
| Cm | 2′-O-methylcytidine |
| Cmnm5s2u | 5-carboxymethylamino-methyl-2- |
| | thioridine |
| Cmnm5u | 5-carboxymethylaminomethyluridine |
| D | Dihydrouridine |
| Fm | 2′-O-methylpseudouridine |
| Gal q | Beta,D-galactosylqueosine |
| Gm | 2′-O-methylguanosine |
| I | Inosine |
| I6a | N6-isopentenyladenosine |
| m1a | 1-methyladenosine |
| m1f | 1-methylpseudouridine |
| m1g | 1-methylguanosine |
| m1I | 1-methylinosine |
| m22g | 2,2-dimethylguanosine |
| m2a | 2-methyladenosine |
| m2g | 2-methylguanosine |
| m3c | 3-methylcytidine |
| m5c | 5-methylcytidine |
| m6a | N6-methyladenosine |
| m7g | 7-methylguanosine |
| Mam5u | 5-methylaminomethyluridine |
| Mam5s2u | 5-methoxyaminomethyl-2-thiouridine |
| Man q | Beta,D-mannosylqueosine |
| Mcm5s2u | 5-methoxycarbonylmethyl-2-thiouridine |
| Mcm5u | 5-methoxycarbonylmethyluridine |
| Mo5u | 5-methoxyuridine |
| Ms2i6a | 2-methylthio-N6-isopentenyladenosine |
| Ms2t6a | N-((9-beta-D-ribofuranosyl-2-methylthiopurine-6- |
| | yl)carbamoyl)threonine |
| Mt6a | N-((9-beta-D-ribofuranosylpurine-6-yl)N-methyl- |
| | carbamoyl)threonine |
| Mv | Uridine-5-oxyacetic acid methylester |
| o5u | Uridine-5-oxyacetic acid (v) |
| Osyw | Wybutoxosine |
| P | Pseudouridine |
| Q | Queosine |
| s2c | 2-thiocytidine |
| s2t | 5-methyl-2-thiouridine |
| s2u | 2-thiouridine |
| s4u | 4-thiouridine |
| T | 5-methyluridine |
| t6a | N-((9-beta-D-ribofuranosylpurine-6- |
| | yl)carbamoyl)threonine |
| Tm | 2′-O-methyl-5-methyluridine |
| Um | 2′-O-methyluridine |
| Yw | Wybutosine |
| X | 3-(3-amino-3-carboxypropyl)uridine, (acp3)u |

A nucleobase may be comprised in a nucleoside or nucleotide, using any chemical or natural synthesis method described herein or known to one of ordinary skill in the art.

Nucleosides. As used herein, a “nucleoside” refers to an individual chemical unit comprising a nucleobase covalently attached to a nucleobase linker moiety. A non-limiting example of a “nucleobase linker moiety” is a sugar comprising 5-carbon atoms (i.e., a “5-carbon sugar”), including but not limited to a deoxyribose, a ribose, an arabinose, or a derivative or an analog of a 5-carbon sugar. Non-limiting examples of a derivative or an analog of a 5-carbon sugar include a 2′-fluoro-2′-deoxyribose or a carbocyclic sugar where a carbon is substituted for an oxygen atom in the sugar ring.

Different types of covalent attachment(s) of a nucleobase to a nucleobase linker moiety are known in the art. By way of non-limiting example, a nucleoside comprising a purine (i.e., A or G) or a 7-deazapurine nucleobase typically covalently attaches the 9 position of a purine or a 7-deazapurine to the 1′-position of a 5-carbon sugar. In another non-limiting example, a nucleoside comprising a pyrimidine nucleobase (i.e., C, T or U) typically covalently attaches a 1 position of a pyrimidine to a 1′-position of a 5-carbon sugar (Kornberg and Baker, 1992).

Nucleotides. As used herein, a “nucleotide” refers to a nucleoside further comprising a “backbone moiety.” A backbone moiety generally covalently attaches a nucleotide to another molecule comprising a nucleotide, or to another nucleotide to form a nucleic acid. The “backbone moiety” in naturally-occurring nucleotides typically comprises a phosphorus moiety, which is covalently attached to a 5-carbon sugar. The attachment of the backbone moiety typically occurs at either the 3′- or 5′-position of the 5-carbon sugar. However, other types of attachments are known in the art, particularly when a nucleotide comprises derivatives or analogs of a naturally-occurring 5-carbon sugar or phosphorus moiety.

Nucleic Acid Analogs. A nucleic acid may comprise, or be composed entirely of, a derivative or analog of a nucleobase, a nucleobase linker moiety and/or backbone moiety that may be present in a naturally-occurring nucleic acid. As used herein a “derivative” refers to a chemically modified or altered form of a naturally-occurring molecule, while the terms “mimic” or “analog” refer to a molecule that may or may not structurally resemble a naturally occurring molecule or moiety, but possesses similar functions. As used herein, a “moiety” generally refers to a smaller chemical or molecular component of a larger chemical or molecular structure. Nucleobase, nucleoside and nucleotide analogs or derivatives are well known in the art, and have been described (see for example, Scheit, 1980, incorporated herein by reference).

Additional non-limiting examples of nucleosides, nucleotides or nucleic acids comprising 5-carbon sugar and/or backbone moiety derivatives or analogs, include those in U.S. Pat. No. 5,681,947 which describes oligonucleotides comprising purine derivatives that form triple helixes with and/or prevent expression of dsDNA; U.S. Pat. Nos. 5,652,099 and 5,763,167 which describe nucleic acids incorporating fluorescent analogs of nucleosides found in DNA or RNA, particularly for use as fluorescent nucleic acids probes; U.S. Pat. No. 5,614,617 which describes oligonucleotide analogs with substitutions on pyrimidine rings that possess enhanced nuclease stability; U.S. Pat. Nos. 5,670,663, 5,872,232 and 5,859,221 which describe oligonucleotide analogs with modified 5-carbon sugars (i.e., modified 2′-deoxyfuranosyl moieties) used in nucleic acid detection; U.S. Pat. No. 5,446,137 which describes oligonucleotides comprising at least one 5-carbon sugar moiety substituted at the 4′ position with a substituent other than hydrogen that can be used in hybridization assays; U.S. Pat. No. 5,886,165 which describes oligonucleotides with both deoxyribonucleotides with 3′-5′ internucleotide linkages and ribonucleotides with 2′-5′ internucleotide linkages; U.S. Pat. No. 5,714,606 which describes a modified internucleotide linkage wherein a 3′-position oxygen of the internucleotide linkage is replaced by a carbon to enhance the nuclease resistance of nucleic acids; U.S. Pat. No. 5,672,697 which describes oligonucleotides containing one or more 5′ methylene phosphonate internucleotide linkages that enhance nuclease resistance; U.S. Pat. Nos. 5,466,786 and 5,792,847 which describe the linkage of a substituent moiety which may comprise a drug or label to the 2′ carbon of an oligonucleotide to provide enhanced nuclease stability and ability to deliver drugs or detection moieties; U.S. Pat. No. 5,223,618 which describes oligonucleotide analogs with a 2 or 3 carbon backbone linkage attaching the 4′ position and 3′ position of adjacent 5-carbon sugar moiety to enhanced cellular uptake, resistance to nucleases and hybridization to target RNA; U.S. Pat. No. 5,470,967 which describes oligonucleotides comprising at least one sulfamate or sulfamide internucleotide linkage that are useful as nucleic acid hybridization probe; U.S. Pat. Nos. 5,378,825, 5,777,092, 5,623,070, 5,610,289 and 5,602,240 which describe oligonucleotides with three or four atom linker moiety replacing phosphodiester backbone moiety used for improved nuclease resistance, cellular uptake and regulating RNA expression; U.S. Pat. No. 5,858,988 which describes hydrophobic carrier agent attached to the 2′-O position of oligonucleotides to enhanced their membrane permeability and stability; U.S. Pat. No. 5,214,136 which describes olignucleotides conjugated to anthraquinone at the 5′ terminus that possess enhanced hybridization to DNA or RNA; enhanced stability to nucleases; U.S. Pat. No. 5,700,922 which describes PNA-DNA-PNA chimeras wherein the DNA comprises 2′-deoxy-erythro-pentofuranosyl nucleotides for enhanced nuclease resistance, binding affinity, and ability to activate RNase H; and U.S. Pat. No. 5,708,154 which describes RNA linked to a DNA to form a DNA-RNA hybrid.

Polyether and Peptide Nucleic Acids. In certain embodiments, it is contemplated that a nucleic acid comprising a derivative or analog of a nucleoside or nucleotide may be used in the methods and compositions of the invention. A non-limiting example is a “polyether nucleic acid,” described in U.S. Pat. No. 5,908,845, incorporated herein by reference. In a polyether nucleic acid, one or more nucleobases are linked to chiral carbon atoms in a polyether backbone.

Another non-limiting example is a “peptide nucleic acid,” also known as a “PNA,” “peptide-based nucleic acid analog” or “PENAM”, described in U.S. Pat. Nos. 5,786,461, 5,891,625, 5,773,571, 5,766,855, 5,736,336, 5,719,262, 5,714,331, 5,539,082, and WO 92/20702, each of which is incorporated herein by reference. Peptide nucleic acids generally have enhanced sequence specificity, binding properties, and resistance to enzymatic degradation in comparison to molecules such as DNA and RNA (Egholm et al., 1993; PCT/EP/01219). A peptide nucleic acid generally comprises one or more nucleotides or nucleosides that comprise a nucleobase moiety, a nucleobase linker moiety that is not a 5-carbon sugar, and/or a backbone moiety that is not a phosphate backbone moiety. Examples of nucleobase linker moieties described for PNAs include aza nitrogen atoms, amido and/or ureido tethers (see for example, U.S. Pat. No. 5,539,082). Examples of backbone moieties described for PNAs include an aminoethylglycine, polyamide, polyethyl, polythioamide, polysulfinamide or polysulfonamide backbone moiety.

In certain embodiments, a nucleic acid analogue such as a peptide nucleic acid may be used to inhibit nucleic acid amplification, such as in PCR, to reduce false positives and discriminate between single base mutants, as described in U.S. Pat. No. 5,891,625. In a non-limiting example, U.S. Pat. No. 5,786,461 describes PNAs with amino acid side chains attached to the PNA backbone to enhance solubility of the molecule. Another example is described in U.S. Pat. Nos. 5,766,855, 5,719,262, 5,714,331 and 5,736,336, which describe PNAs comprising naturally- and non-naturally-occurring nucleobases and alkylamine side chains that provide improvements in sequence specificity, solubility and/or binding affinity relative to a naturally occurring nucleic acid.

Preparation of Nucleic Acids. A nucleic acid may be made by any technique known to one of ordinary skill in the art, such as for example, chemical synthesis, enzymatic production or biological production. Non-limiting examples of a synthetic nucleic acid (e.g., a synthetic oligonucleotide), include a nucleic acid made by in vitro chemically synthesis using phosphotriester, phosphite or phosphoramidite chemistry and solid phase techniques such as described in EP 266 032, incorporated herein by reference, or via deoxynucleoside H-phosphonate intermediates as described by Froehler et al., 1986 and U.S. Pat. No. 5,705,629, each incorporated herein by reference. In the methods of the present invention, one or more oligonucleotide may be used. Various different mechanisms of oligonucleotide synthesis have been disclosed in for example, U.S. Pat. Nos. 4,659,774, 4,816,571, 5,141,813, 5,264,566, 4,959,463, 5,428,148, 5,554,744, 5,574,146, 5,602,244, each of which is incorporated herein by reference.

A non-limiting example of an enzymatically produced nucleic acid include one produced by enzymes in amplification reactions such as PCR™ (see for example, U.S. Pat. No. 4,683,202 and U.S. Pat. No. 4,682,195, each incorporated herein by reference), or the synthesis of an oligonucleotide described in U.S. Pat. No. 5,645,897, incorporated herein by reference. A non-limiting example of a biologically produced nucleic acid includes a recombinant nucleic acid produced (i.e., replicated) in a living cell, such as a recombinant DNA vector replicated in bacteria (see for example, Sambrook et al. 2001, incorporated herein by reference).

Purification of Nucleic Acids. A nucleic acid may be purified on polyacrylamide gels, cesium chloride centrifugation gradients, or by any other means known to one of ordinary skill in the art (see for example, Sambrook et al., 2001, incorporated herein by reference).

In certain aspect, the present invention concerns a nucleic acid that is an isolated nucleic acid. As used herein, the term “isolated nucleic acid” refers to a nucleic acid molecule (e.g., an RNA or DNA molecule) that has been isolated free of, or is otherwise free of, the bulk of the total genomic and transcribed nucleic acids of one or more cells. In certain embodiments, “isolated nucleic acid” refers to a nucleic acid that has been isolated free of, or is otherwise free of, bulk of cellular components or in vitro reaction components such as for example, macromolecules such as lipids or proteins, small biological molecules, and the like.

Nucleic Acid Complements. The present invention also encompasses a nucleic acid that is complementary to a target nucleic acid. A nucleic acid is “complement(s)” or is “complementary” to another nucleic acid when it is capable of base-pairing with another nucleic acid according to the standard Watson-Crick, Hoogsteen or reverse Hoogsteen binding complementarity rules. As used herein “another nucleic acid” may refer to a separate molecule or a spatial separated sequence of the same molecule.

As used herein, the term “complementary” or “complement(s)” also refers to a nucleic acid comprising a sequence of consecutive nucleobases or semiconsecutive nucleobases (e.g., one or more nucleobase moieties are not present in the molecule) capable of hybridizing to another nucleic acid strand or duplex even if less than all the nucleobases do not base pair with a counterpart nucleobase. In certain embodiments, a “complementary” nucleic acid comprises a sequence in which about 70%, about 71%, about 72%, about 73%, about 74%, about 75%, about 76%, about 77%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, to about 100%, and any range derivable therein, of the nucleobase sequence is capable of base-pairing with a single or double stranded nucleic acid molecule during hybridization. In certain embodiments, the term “complementary” refers to a nucleic acid that may hybridize to another nucleic acid strand or duplex in stringent conditions, as would be understood by one of ordinary skill in the art.

In certain embodiments, a “partly complementary” nucleic acid comprises a sequence that may hybridize in low stringency conditions to a single or double stranded nucleic acid, or contains a sequence in which less than about 70% of the nucleobase sequence is capable of base-pairing with a single or double stranded nucleic acid molecule during hybridization.

Hybridization. As used herein, “hybridization”, “hybridizes” or “capable of hybridizing” is understood to mean the forming of a double or triple stranded molecule or a molecule with partial double or triple stranded nature. The term “anneal” as used herein is synonymous with “hybridize.” The term “hybridization”, “hybridize(s)” or “capable of hybridizing” encompasses the terms “stringent condition(s)” or “high stringency” and the terms “low stringency” or “low stringency condition(s).”

As used herein “stringent condition(s)” or “high stringency” are those conditions that allow hybridization between or within one or more nucleic acid strand(s) containing complementary sequence(s), but precludes hybridization of random sequences. Stringent conditions tolerate little, if any, mismatch between a nucleic acid and a target strand. Such conditions are well known to those of ordinary skill in the art, and are preferred for applications requiring high selectivity. Non-limiting applications include isolating a nucleic acid, such as a gene or a nucleic acid segment thereof, or detecting at least one specific mRNA transcript or a nucleic acid segment thereof, and the like.

Stringent conditions may comprise low salt and/or high temperature conditions, such as provided by about 0.02 M to about 0.15 M NaCl at temperatures of about 50° C. to about 70° C. It is understood that the temperature and ionic strength of a desired stringency are determined in part by the length of the particular nucleic acid(s), the length and nucleobase content of the target sequence(s), the charge composition of the nucleic acid(s), and to the presence or concentration of formamide, tetramethylammonium chloride or other solvent(s) in a hybridization mixture.

It is also understood that these ranges, compositions and conditions for hybridization are mentioned by way of non-limiting examples only, and that the desired stringency for a particular hybridization reaction is often determined empirically by comparison to one or more positive or negative controls. Depending on the application envisioned it is preferred to employ varying conditions of hybridization to achieve varying degrees of selectivity of a nucleic acid towards a target sequence. In a non-limiting example, identification or isolation of a related target nucleic acid that does not hybridize to a nucleic acid under stringent conditions may be achieved by hybridization at low temperature and/or high ionic strength. Such conditions are termed “low stringency” or “low stringency conditions”, and non-limiting examples of low stringency include hybridization performed at about 0.15 M to about 0.9 M NaCl at a temperature range of about 20° C. to about 50° C. Of course, it is within the skill of one in the art to further modify the low or high stringency conditions to suite a particular application.

Nucleic Acid Aptamers. In some embodiments the target binding agents according to the invention are nucleic acid aptamers. Nucleic acid aptamers are the products of directed molecular evolution, also known as SELEX or sexual PCR. The term “aptamer” was originally coined by Ellington and Szostak to describe the RNA products of directed molecular evolution, a process in which a nucleic acid molecule that binds with high affinity to a desired target ligand is isolated from large library of random DNA sequences (Ellington and Szostak, 1990). The process involves performing several tandem iteratations of affinity separation, e.g., using a solid support to which the desired ligand is bound, followed by polymerase chain reaction (PCR) to amplify ligand-eluted nucleic acids. Each round of affinity separation thus enriches the nucleic acid population for molecules that successfully bind the desired target ligand. In this manner, Ellington and Szostak enriched an initially random pool of RNAs to yield aptamers that specifically bound organic dye molecules such as Cibacron Blue. Certain of the aptamers obtained could discriminate between Cibacron Blue and other dyes of similar structure, demonstrating specificity of the technique. Aptamers can even be engineered to distinguish between stereoisomers that differ only by optical rotation at a single chiral center (Famulok and Szostak, 1992). Originally, it was thought that RNA aptamers would be more suitable for ligand recognition, in view of established knowledge of naturally occurring RNAs with higher ordered three-dimensional structures (e.g., rRNA or transfer RNA, tRNA). However, single-stranded DNA molecules produced by asymmetric PCR amplification were also shown effective (Ellington and Szostak, 1992). It should be noted that aptamers can be prepared from nucleotide analogs, such as phosphorothioate nucleotides, which can offer increased aptamer stability under physiological conditions. Standard techniques are available for linking nucleic acids, to other chemical moieties, without substantial loss of protein-recognition capability.

The principles of directed molecular evolution encompass the production of aptamers that bind with high affinity to proteins, such as DNA binding proteins, including transcription factors (Tuerk and Gold, 1990; Famulok and Szostak 1992). Recently, an aptamer has been reported that binds with high affinity to the extracellular protein thrombin (Bock et al., 1992). High affinity aptamers can be generated even against proteins for which there is little or no structural or ligand-recognition information available (Famulok and Szostak, 1992). Thus, aptamers that bind specific targets can be generated, through available techniques, that bind to virtually any desired selected-cell associated protein, whether or not the protein has a known natural ligand or endogenous genomic binding site. Techniques have even been developed wherein the molecular evolution process is performed by robotics in order to further streamline production of specific aptamers (U.S. Pat. Nos. 6,569,620 and 6,716,580).

In certain applications, the use of DNA aptamers has several advantages over RNA including increased nuclease stability, in particular plasma nuclease stability, and ease of amplification by PCR or other methods. RNA generally is converted to DNA prior to amplification using reverse transcriptase, a process that is not equally efficient with all sequences, resulting in loss of some aptamers from a selected pool

2. Antibodies

Briefly, an antibody is prepared by immunizing an animal with an immunogen and collecting antisera from that immunized animal. A wide range of animal species can be used for the production of antisera. Typically an animal used for production of anti-antisera is a non-human animal including rabbits, mice, rats, hamsters, pigs or horses. Monoclonal antibodies may be prepared and characterized by standard techniques (see, e.g., Harlow and Lane, 1988; incorporated herein by reference).

As is well known in the art, a given composition may vary in its immunogenicity. It is often necessary therefore to boost the host immune system, as may be achieved by coupling a peptide or polypeptide immunogen to a carrier. Exemplary and preferred carriers are keyhole limpet hemocyanin (KLH) and bovine serum albumin (BSA). Other albumins such as ovalbumin, mouse serum albumin or rabbit serum albumin can also be used as carriers. Means for conjugating a polypeptide to a carrier protein are well known in the art and include glutaraldehyde, m-maleimidobencoyl-N-hydroxysuccinimide ester, carbodiimide and bis-biazotized benzidine. As also is well known in the art, the immunogenicity of a particular immunogen composition can be enhanced by the use of non-specific stimulators of the immune response, known as adjuvants. Exemplary and preferred adjuvants include complete Freund's adjuvant (a non-specific stimulator of the immune response containing killed Mycobacterium tuberculosis), incomplete Freund's adjuvants and aluminum hydroxide adjuvant.

The amount of immunogen composition used in the production of antibodies varies upon the nature of the immunogen as well as the animal used for immunization. A variety of routes can be used to administer the immunogen (subcutaneous, intramuscular, intradermal, intravenous and intraperitoneal). A second, booster, injection may also be given. The process of boosting and titering is repeated until a suitable titer is achieved. When a desired level of immunogenicity is obtained, the immunized animal can be used to generate mAbs.

MAbs may be readily prepared through use of well-known techniques, such as those exemplified in U.S. Pat. No. 4,196,265, incorporated herein by reference. Typically, this technique involves immunizing a suitable animal with a selected immunogen composition, e.g., a purified or partially purified PKD protein, polypeptide or peptide or cell expressing high levels of PKD. The immunizing composition is administered in a manner effective to stimulate antibody producing cells. Rodents such as mice and rats are preferred animals; however, the use of rabbit, sheep frog cells is also possible. The use of rats may provide certain advantages (Goding, 1986), but mice are preferred, with the BALB/c mouse being most preferred as this is most routinely used and generally gives a higher percentage of stable fusions.

Following immunization, somatic cells with the potential for producing antibodies, specifically B-lymphocytes (B-cells), are selected for use in the mAb generating protocol. These cells may be obtained from biopsied spleens, tonsils or lymph nodes, or from a peripheral blood sample. Spleen cells and peripheral blood cells are preferred, the former because they are a rich source of antibody-producing cells that are in the dividing plasmablast stage, and the latter because peripheral blood is easily accessible. Often, a panel of animals will have been immunized and the spleen of animal with the highest antibody titer will be removed and the spleen lymphocytes obtained by homogenizing the spleen with a syringe. Typically, a spleen from an immunized mouse contains approximately 5×10⁷ to 2×10⁸ lymphocytes.

The antibody-producing B lymphocytes from the immunized animal are then fused with cells of an immortal myeloma cell, generally one of the same species as the animal that was immunized. Myeloma cell lines suited for use in hybridoma-producing fusion procedures preferably are non-antibody-producing, have high fusion efficiency, and enzyme deficiencies that render then incapable of growing in certain selective media which support the growth of only the desired fused cells (hybridomas).

Any one of a number of myeloma cells may be used, as are known to those of skill in the art (Goding, 1986; Campbell, 1984). For example, where the immunized animal is a mouse, one may use P3-X63/Ag8, P3-X63-Ag8.653, NS1/1.Ag 4 1, Sp210-Ag14, FO, NSO/U, MPC-11, MPC11-X45-GTG 1.7 and S194/5XX0 Bul; for rats, one may use R210.RCY3, Y3-Ag 1.2.3, IR983F and 4B210; and U-266, GM1500-GRG2, LICR-LON-HMy2 and UC729-6 are all useful in connection with cell fusions.

Methods for generating hybrids of antibody-producing spleen or lymph node cells and myeloma cells usually comprise mixing somatic cells with myeloma cells in a 2:1 ratio, though the ratio may vary from about 20:1 to about 1:1, respectively, in the presence of an agent or agents (chemical or electrical) that promote the fusion of cell membranes. Fusion methods using Sendai virus have been described (Kohler and Milstein, 1975; 1976), and those using polyethylene glycol (PEG), such as 37% (v/v) PEG, by Gefter et al., (1977). The use of electrically induced fusion methods is also appropriate (Goding, 1986).

Fusion procedures usually produce viable hybrids at low frequencies, around 1×10⁻⁶ to 1×10⁻⁸. However, this does not pose a problem, as the viable, fused hybrids are differentiated from the parental, unfused cells (particularly the unfused myeloma cells that would normally continue to divide indefinitely) by culturing in a selective medium. The selective medium is generally one that contains an agent that blocks the de novo synthesis of nucleotides in the tissue culture media. Exemplary and preferred agents are aminopterin, methotrexate, and azaserine. Aminopterin and methotrexate block de novo synthesis of both purines and pyrimidines, whereas azaserine blocks only purine synthesis. Where aminopterin or methotrexate is used, the media is supplemented with hypoxanthine and thymidine as a source of nucleotides (HAT medium). Where azaserine is used, the media is supplemented with hypoxanthine.

The preferred selection medium is HAT. Only cells capable of operating nucleotide salvage pathways are able to survive in HAT medium. The myeloma cells are defective in key enzymes of the salvage pathway, e.g., hypoxanthine phosphoribosyl transferase (HPRT), and they cannot survive. The B cells can operate this pathway, but they have a limited life span in culture and generally die within about two weeks. Therefore, the only cells that can survive in the selective media are those hybrids formed from myeloma and B-cells.

This culturing provides a population of hybridomas from which specific hybridomas are selected. Typically, selection of hybridomas is performed by culturing the cells by single-clone dilution in microtiter plates, followed by testing the individual clonal supernatants (after about two to three weeks) for the desired reactivity. The assay should be sensitive, simple and rapid, such as radioimmunoassays, enzyme immunoassays, cytotoxicity assays, plaque assays, dot immunobinding assays, and the like.

Selected hybridomas are serially diluted and cloned into individual antibody-producing cell lines, which clones can then be propagated indefinitely to provide mAbs. The cell lines may be exploited for mAb production in two basic ways. A sample of the hybridoma can be injected (often into the peritoneal cavity) into a histocompatible animal of the type that was used to provide the somatic and myeloma cells for the original fusion. The injected animal develops tumors secreting the specific monoclonal antibody produced by the fused cell hybrid. The body fluids of the animal, such as serum or ascites fluid, can then be tapped to provide mAbs in high concentration. The individual cell lines could also be cultured in vitro, where the mAbs are naturally secreted into the culture medium from which they can be readily obtained in high concentrations. mAbs produced by either means may be further purified, if desired, using filtration, centrifugation and various chromatographic methods such as HPLC or affinity chromatography.

### II. MASS SPECTROMETRY

Any of a variety commercially available instruments may be use for MS analysis, such as LDI MS sample analysis according to the methods of the invention. For instance, LDI MS according to the invention can be carried out via any of the methods that are well known to those in the art. Such methods are described in U.S. Pat. Nos. 6,855,925, 6,809,315, 6,756,586, 6,707,038, 5,808,300, 5,572,023, 5,078,135, 4,908,512, 4,820,648, Spengler et al. (2002), Hillenkamp et al. (1975), Pacholski et al. (1999), Xu et al. (2004a), Xu et al. (2004b), Tolstogouzov et al. (1994), Seydel et al. (1992), Rudenauer Anal. (1994), Rousell et al. (2004), McMahon et al. (1995), Lewis et al. (2003), Laiko et al. (2002), Hercules et al. (1987), Guest (1984), Collive et al. (1997), Chandra (2003), Boon et al. (2001), Bhattacharya et al. (2002), Berthold et al. (1995), Brunelle et al. (2005), Touboul et al. (2005) and Touboul et al. (2004) each incorporated herein by reference.

A. Sample Preparation

In general, all reasonable efforts should be made to reduce excessive contamination in the samples. Always use the best quality solvents, reagents and samples. HPLC-grade solvents should be the standard in studies. Keep all samples in plastic containers. Glass containers can cause irreversible sample losses through adsorption on the walls, and release alkali metals into the analyte solution.

Optimum sample handling conditions for biological preparations usually involve non-volatile salts. Desalting might be necessary in the presence of excessive cationization, decreased resolution or signal suppression. Whenever possible, it is best to remove the salts prior to sample analysis. There is a competition between protonation and cationization in when salts are present, and the choice between the two processes is still the subject of investigation.

When working with complex biological materials it is often necessary to use detergents, otherwise the proteins, specially at <mM concentrations, will be rapidly adsorbed on accessible surfaces. Additionally in some cases detergents will reduce the level of non-specific binding of mass tagged complexes. For instance, the effect of detergents on LDI spectra depends on the type of detergent and sample. The effects of particular detergents in the case of MALDI analysis have been examined.

Nonionic detergents (TritonX-100, Triton X-114, N-octylglucoside and Tween 80) do not interfere significantly with sample preparation. In fact, it has even been reported that Triton X-100, in a concentration up to 1%, is compatible with MALDI and in some cases it can improve the quality of spectra. N-octylglucoside has been shown to enhance the MALDI-MS response of the larger peptides in digest mixtures. The addition of nonionic detergents is often a requirement for the analysis of hydrophobic proteins. Common detergents such as PEG and Triton, added during protein extraction from cells and tissues, desorb more efficiently than peptides and proteins and can effectively overwhelm the ion signals. Detergents often provide good internal calibration peaks in the low mass range of the mass spectrum.

Ionic detergents, and particularly sodium dodecyl sulfate (SDS), can severely interfere with MALDI even at very low concentrations. Concentrations of SDS above 0.1% must be reduced by sample purification prior to crystallization with the matrix. The seriousness of this effect cannot be ignored given the wide application of MALDI to the analysis of proteins separated by SDS-PAGE. Polyacrylamide gel electrophoresis introduces sodium, potassium and SDS contamination to the sample, and it also reduces the recovered concentration of analyte. Once a protein has been coated with SDS, simply removing the excess SDS from the solution will not improve sample prep for MALDI: the SDS shell must also be removed. Typical purification schemes involve two phase extraction such as reversed-phase chromatography or liquid-liquid extraction. The removal of SDS from protein samples prior to MALDI mass spectrometry is an important issue.

With IMS as the detection mechanism, the ultimate spatial resolution obtainable depends on both the sample preparation and instrument resolution. Most commercial MALDI instruments, for example, can obtain a maximum resolution of approximately 25-30 microns (Stoecki et al., 2001). Similar to other microscopic techniques, the ultimate resolution achievable depends on the specific sample being analyzed, the tissue preparation techniques and the application of the matrix material. Maintaining the spatial positions of the RNA and proteins during sample processing and detection is particularly important.

B. Substrate Selection

When designing effective LDI sample preparation methods for analysis, attention must be given to the interaction of analytes with the substrate.

Most LDI samples are prepared on and desorbed/ionized from multi-well metallic sample-plates made out of vacuum compatible stainless steel or aluminum. The role of the metal substrate in the desorption/ionization process is not well understood, but the surface conductivity of the metal is often considered essential to preserve the integrity of the electrostatic field around the sample during ion ejection. The hard metals can be machined and formed to high precision, and can also be easily cleaned and polished to provide the smooth surfaces needed for high resolution and high mass accuracy. The analyte/matrix crystals strongly adhere to metal surfaces providing very rugged samples that can be stored for long periods of time and washed for purification purposes.

Both stainless steel and aluminum do not contribute metal ions to the cationization of the analyte during ion formation. Copper as a substrate, on the other hand, has been demonstrated to form adducts with analyte during desorption (Russell et al., 1999).

Most LDI sources use a solid sample plate and irradiation is done from the front (reflection geometry); however, use of transmission geometry to desorb the analyte samples is possible. In the transmission geometry the laser irradiation and the mass spectrometer's analyzer are on opposite sides of the thin sample. The substrates used in the two case studies were quartz and plastic-coated grids (Formvar on zinc or copper).

Plastic is the second most common material used in MALDI (or LDI) sources as a substrate. Significant attention must be given to the interaction of the peptides and proteins with the polymeric surface (Kinsel et al., 1999). The influence of polymer surface-protein binding affinity on protein ion signals has been studied, and it showed that as the surface-protein binding affinity increases the efficiency of MALDI of the protein decreases. ITO-coated, conductive glass may also be used for IMS. Chaurand et al. (2004) have recently demonstrated the integration of histological methods and IMS.

The use of plastic membranes as sample supports has recently been adopted as a means of both sample purification and sample delivery into the mass spectrometer. If the analyte can be selectively adsorbed (hydrophobic interactions) onto the membrane, interfering substances can be washed off while the analyte is retained. Purification by on-probe washing results in lower sample loss than pre-purification by traditional methods. Polyethylene and polypropylene surfaces have been used to conduct on-probe sample purification. (Woods et al., 1998) Similarly, poly(vinylidene fluoride) based membranes have been used to extract and purify proteins from bulk cell extracts and for the removal of detergents, and a method has been developed for probe surface derivatization to construct monolayers of C18 on LDI Probes (Orlando et al., 1997). Non-porous polyurethane membrane has been used as the collection device and transportation medium of blood sample analysis, followed by direct desorption from the same membrane substrate in a LDI-TOF spectrometer (Perreault et al., 1998). Sample purification and proteolytic digest right on the probe tip, with minimal sample loss, was also possible with this substrate. Nitrocellulose, used as a sample additive or as a pre-deposited substrate, has been used by several researchers to improve MALDI spectra quality, to induce matrix signal suppression, and to rapidly detect and identify large proteins from Escherichia coli whole cell lysates in the mass range from 25-500 kDa.

### III. METHODS

The present invention may be exploited in a variety of ways. In particular embodiments, one may obtain information regarding disease states such as hyperproliferative diseases (e.g., cancers), inflammatory diseases, infectious diseases, genetic or developmental diseases, or responses to environmental insults (e.g., poisons or toxins). By identifying the aberrant expression or localization of target molecules, one can gain an increased understanding of the disease state. This in turn will permit one to diagnose disease based on molecular rather than clinical symptoms, and to monitor disease states, particular during the course of therapy to determine response.

Moreover, the given the number of changes that can be observed, the ability to distinguish normal from abnormal tissue is greatly enhanced. This could be particularly important in providing early stage diagnosis of pathologic events, thereby permitting earlier therapeutic intervention. This technology also may be applied to assessing the efficacy of surgical removal of diseased tissue, or to identifying the margins of diseased tissue during surgery.

In another application, the present invention may be used to screen for therapeutic methods. In one scenario, one can assess a plurality of disease markers, including those that are both up- and down-regulated in the disease state, at the same time and in the same sample. Providing a drug to a cell, tissue or organism, followed by obtaining expression level or localization using the mass tag complexes of the present invention, permits one to assess the impact of the drug on multiple relevant disease markers.

In an additional embodiment, one may screen for the presence of drug metabolites or other metabolic compounds, including both their quantitation and localization. This may be done in conjunction with, or separately from, assessment of nucleic acid and proteins that are impacted by the drug.

### IV. KITS

The mass tag complexes, or components thereof, may be comprised in a kit. The kits will thus comprise, in suitable container means, a mass tag complex or population thereof, or the individual mass tags, cleavage sites other reagents for the preparation of mass tag complexes.

The components of the kits may be packaged either in aqueous media or in lyophilized form. The container means of the kits will generally include at least one vial, test tube, flask, bottle, syringe or other container means, into which a component may be placed, and preferably, suitably aliquoted. Where there are more than one component in the kit, the kit also will generally contain a second, third or other additional container into which the additional components may be separately placed.

The kits of the present invention also will typically include a means for containing the reagent containers in close confinement for commercial sale. Such containers may include injection or blow-molded plastic containers into which the desired vials are retained.

### V. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Mass Tagged Antibodies

An example strategy the mass tag an antibody is presented in FIG. 2. The approach involves a Wittig coupling of appropriately substituted ortho-nitro aldehydes with stabilized Wittig reagents, providing ortho-nitro substituted cinnamate esters. Reduction of the nitro group provides ortho-amino compounds that can be hydrolyzed and converted to N-hydroxysuccinimide (NHS) esters that react with free amino groups on peptides and proteins under mild, neutral conditions. Compounds are prepared that have R′=H or methyl (Me) and with a variety of R groups substituted on the cinnamate aromatic ring.

Coupling the tags to antibodies. Tags are then coupled to antibodies using succinimide ester chemistry, as exemplified in FIG. 3. Using this chemistry, antibodies are effectively mass tagged. An example is given in FIG. 4 in which a ScFv single chain antibody is reacted with a mass tag synthesized as described above. The molecular weight (MW) of the antibody was measured by MALDI time-of-flight mass spectrometry before (FIG. 4A) and after (FIG. 4B) the tagging reaction. After reaction, clear MW shifts by increments of 202 atomic mass units (amu) are observed indicating that on average, two tags were coupled to the antibody.

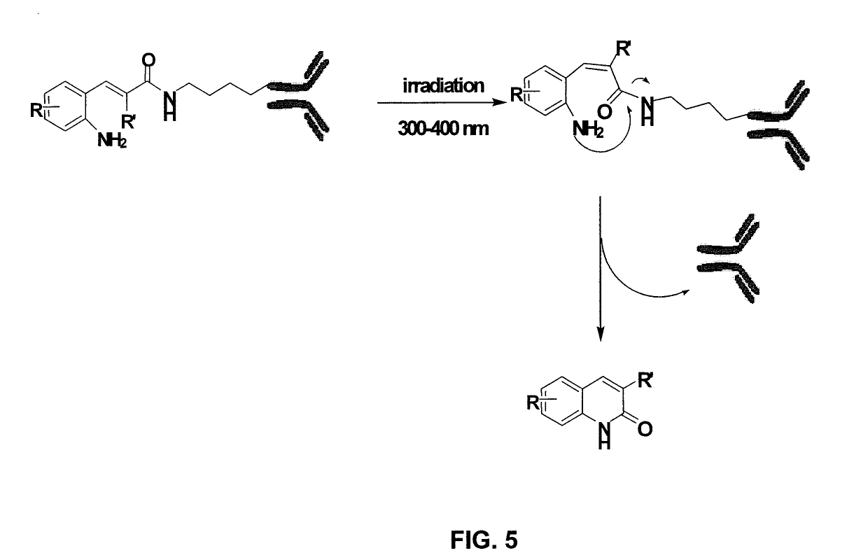

Photochemistry. A cinnamate UV photochemistry was described by Porter et al., (1989) and is detailed in FIG. 5. Upon irradiation with UV light (e.g., 300-400 nm), the mass tag is liberated. In certain cases, ionization occurs by loss of an electron, forming a radical ion of general formula [M]+. FIG. 6 shows a laser desorption time-of-flight mass spectrum obtained after direct irradiation of the tagged IgG shown in FIG. 4. In this example a nitrogen laser (N₂) with a wavelength of 337 nm is used at a pulse width of ˜2.5 ns. The threshold energy necessary for achieving the photoreaction and ionization of the mass tag is in the order of (2 μJ/pulse). The resulting spectrum displays a clear signal at m/z 202 resulting from the liberation and ionization of the tag induced by the laser light.

### Example 2

### Detection of Mass Tagged Antibodies

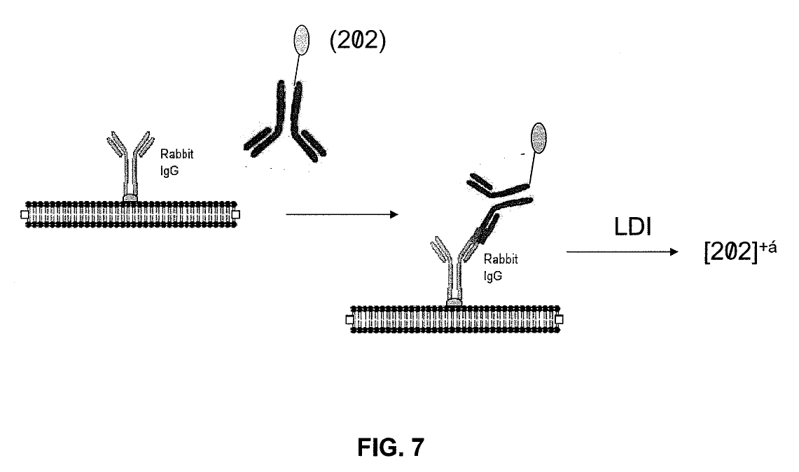

Additional studies demonstrate that tagged IgG is detectable when used to specifically recognize an antigen bound to a surface. For this study a rabbit IgG (2 μL drop of a 1 mg/mL solution) is first immobilized on a nitrocellulose membrane as shown in FIG. 7. The membrane is then incubated with bovine serum albumin to completely bock further non-specific binding. An anti-rabbit goat polyclonal IgG previously tagged with a photocleavable tag (e.g., as described in FIG. 4) is added and the membrane is then analyzed under laser desorption conditions in a time-of-flight mass spectrometer. The localized binding of the goat anti-rabbit IgG is detected by monitoring of the mass tag signature at m/z 202. The intensity of the m/z 202 ion is plotted as a function of the x/y sample stage position and is presented in FIG. 8. A significantly stronger intensity is observed for the m/z 202 mass tag from the nitrocellulose area on which the rabbit IgG was deposited.

### Example 3

### Quantitative Analysis

One highly preferred aspect of the described mass tag system is in the precise relative and absolute quantitation of the amount of antigen present or immobilized on surfaces such as tissue section. To demonstrate such quantitation, the studies from example 2 are repeated with various amounts of rabbit IgG. 2 μL of 0.2, 0.4, 0.6 and 0.8 mg/mL rabbit IgG solutions are immobilized on a nitrocellulose membrane, reacted with the tagged goat anti-rabbit IgG and mass analyzed. The m/z 202 mass tag intensities are presented in FIG. 9 showing a linear trend as a function of IgG concentration.

### Example 4

### Mass Tag Signal Amplification

Benzoin ester mass tag chemistry. Preparation of the mass tag: different benzoin compounds can be transformed to acids which are then activated by succinic esters.

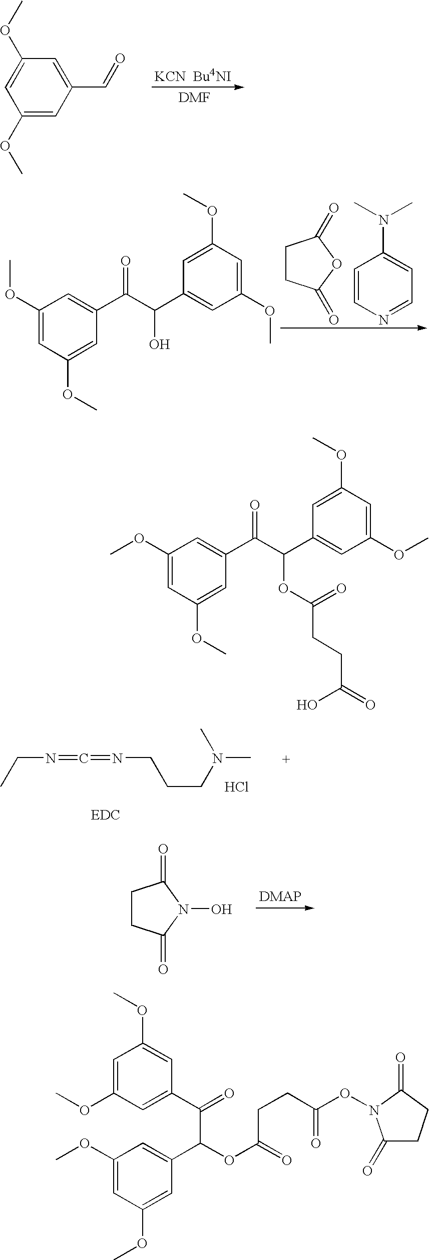

The method of modification of a dendrimer or antibody by benzoin tag is same as for the cinnamate mass tag. Photolyzation of benzoin ester gives positive charged species, which lead to a more sensitive detection of the mass tags.

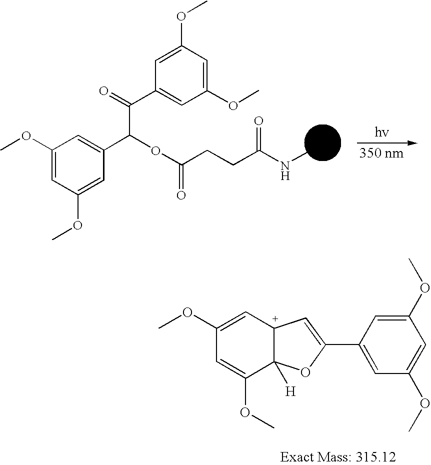

### Example 5

### Mass Tag Signal Amplification

To detect and quantify the presence of antigens in low abundance, an amplification system based on dendrimers may be used. For PAMAM dendrimers (see Patri et al., 2004), which have amine groups on the surface, the number of amine groups depends exponentially on the dendrimer generation (=2n+2).

Before attaching any tags on the dendrimer, one necessary step is to modify the dendrimer with glycidol, succinic anhydride, acetic anhydride or Y-butyrolactone to reduce potential non-specific binding of the dendrimer on different surfaces. One typical experiment for modification is: 5 mg of PAMAM dendrimer G6 in 0.5 mL of DMSO is added to 1.2 mg (160 eq) of γ-butyrolactone. The reaction mixture is stirred at room temperature for 24 hours then filtered using a Sephadex G-25 PD-10 column with a pH 7.2 PBS buffer.

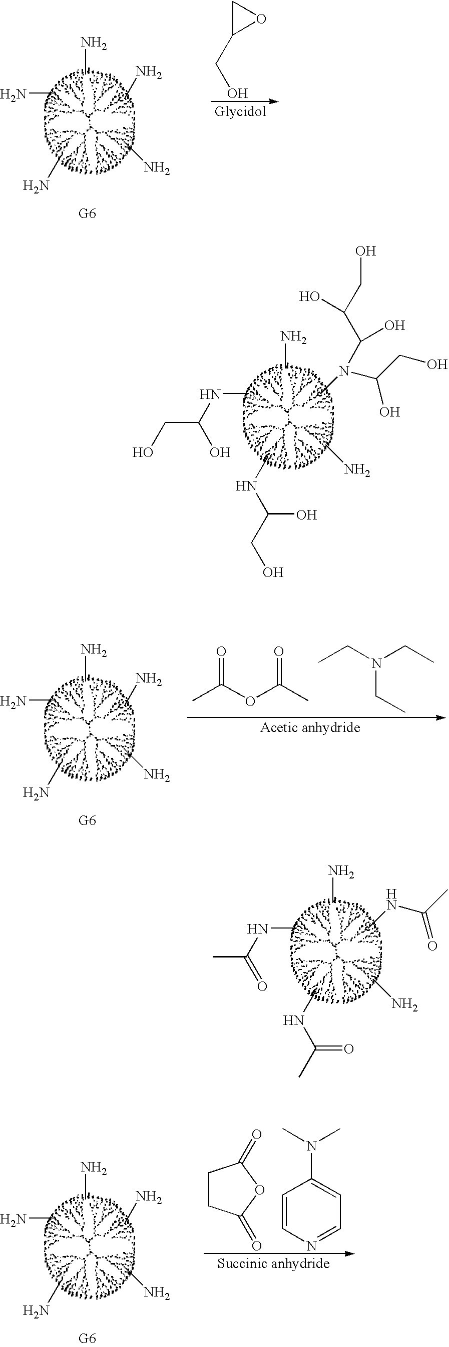

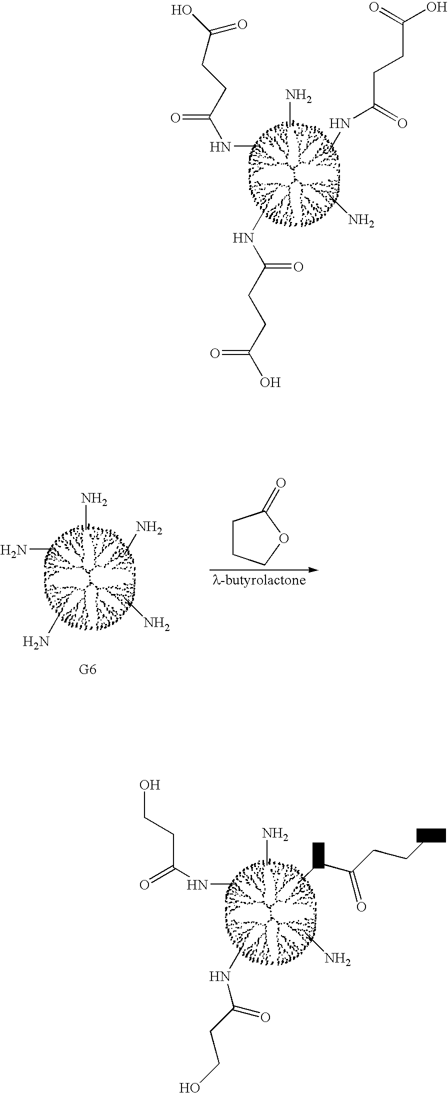

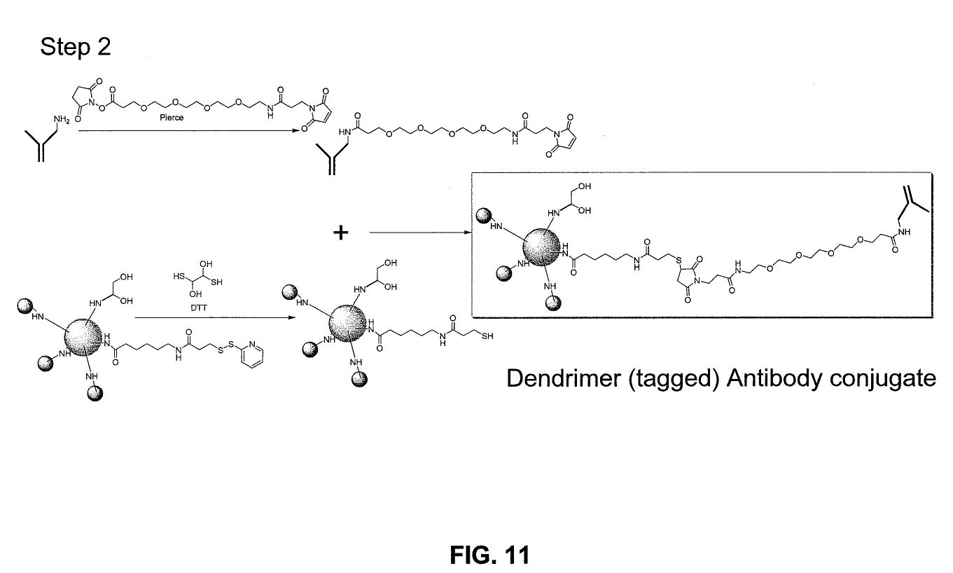

Modified PAMAM dendrimers are then tagged with the mass tagging reagents with certain equivalences through the succinimide chemistry. The reaction mixture is filtered again using a PD-10 column to remove excess tagging reagent. The tagged dendrimer can then be coupled to different crosslinkers, e.g., SPDP (3-(2-pyridyldithio)-propionate) linker. Next, a SMCC linker (succinimidyl-4-(N-maleimidomethyl)cyclohexane-1-carboxylate) can be introduced on to the antibody. Since SMCC is a sulfhydryl-reactive maleimide group, the SPDP linker on dendrimer can release a sulfhydryl group by reduction and conjugate with the antibody via the SMCC linker (FIG. 11). Therefore, the antibody activity can be preserved by minimum modification while the signal of the mass tag can be maximized through dendrimer surface amine group modification. In certain cases, an amplification factor of up to 4000 can be achieved for a 10th generation dendrimer.

Other different cross linkers can be used, e.g., SANH (succinimidyl 4-hydrazinonicotinate acetone hydrazone)/SFB (succinimidyl 4-formylbenzoate) or BSOCOES (Bis[2-(succinimidooxycarbonyloxy)ethyl]sulfone) as shown below:

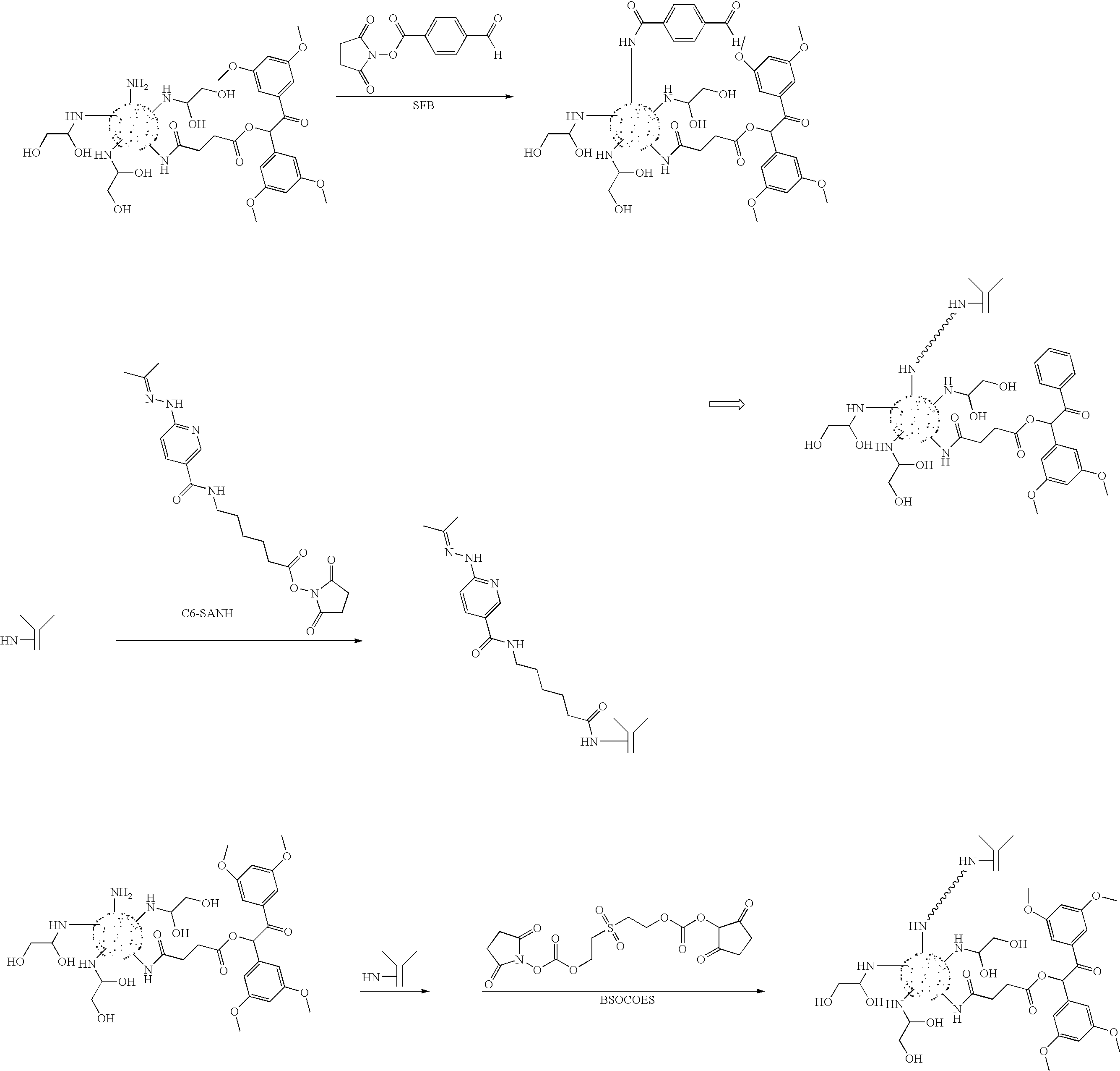

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### VI. REFERENCES

The following references, to the extent that they provide exemplary procedural or other details supplementary to those set forth herein, are specifically incorporated herein by reference.
U.S. Pat. No. 4,196,265
U.S. Pat. No. 4,659,774
U.S. Pat. No. 4,682,195
U.S. Pat. No. 4,683,202
U.S. Pat. No. 4,816,571
U.S. Pat. No. 4,820,648
U.S. Pat. No. 4,908,512
U.S. Pat. No. 4,959,463
U.S. Pat. No. 5,078,135
U.S. Pat. No. 5,141,813
U.S. Pat. No. 5,214,136
U.S. Pat. No. 5,223,618
U.S. Pat. No. 5,264,566
U.S. Pat. No. 5,378,825
U.S. Pat. No. 5,428,148
U.S. Pat. No. 5,446,137
U.S. Pat. No. 5,466,786
U.S. Pat. No. 5,470,967
U.S. Pat. No. 5,539,082
U.S. Pat. No. 5,554,744
U.S. Pat. No. 5,572,023
U.S. Pat. No. 5,574,146
U.S. Pat. No. 5,602,240
U.S. Pat. No. 5,602,244
U.S. Pat. No. 5,610,289
U.S. Pat. No. 5,614,617
U.S. Pat. No. 5,623,070
U.S. Pat. No. 5,645,897
U.S. Pat. No. 5,652,099
U.S. Pat. No. 5,670,663
U.S. Pat. No. 5,672,697
U.S. Pat. No. 5,681,947
U.S. Pat. No. 5,700,922
U.S. Pat. No. 5,705,629
U.S. Pat. No. 5,708,154
U.S. Pat. No. 5,714,331
U.S. Pat. No. 5,714,606
U.S. Pat. No. 5,719,262
U.S. Pat. No. 5,736,336
U.S. Pat. No. 5,763,167
U.S. Pat. No. 5,766,855
U.S. Pat. No. 5,773,571
U.S. Pat. No. 5,777,092
U.S. Pat. No. 5,786,461
U.S. Pat. No. 5,792,847
U.S. Pat. No. 5,808,300
U.S. Pat. No. 5,858,988
U.S. Pat. No. 5,859,221
U.S. Pat. No. 5,872,232
U.S. Pat. No. 5,886,165
U.S. Pat. No. 5,891,625
U.S. Pat. No. 5,908,845
U.S. Pat. No. 6,569,620
U.S. Pat. No. 6,707,038
U.S. Pat. No. 6,716,580
U.S. Pat. No. 6,756,586
U.S. Pat. No. 6,809,315
U.S. Pat. No. 6,855,925
U.S. Patent Publication No. 20050196786
Berthold et al., Surf. Interface Anal., 23:393-398, 1995.
Bhattacharya et al., Anal. Chem., 74:2228-2231, 2002.
Bock et al., Nature 355:564-566, 1992.
Boon et al., Chimia., 55:952-960, 2001.
Brunelle et al., J. Mass Spectrom., 40:985-999, 2005.
Campbell et al., Am. Rev. Respir. Dis., 130(3):417-423, 1984.
Chandra, Appl. Surf. Sci., 203:679-683, 2003.
Chaurand et al., Anal Chem. 76:1145-55, 2004.
Chaurand et al., Curr. Opin. Chem. Biol., 6:676-81, 2002.
Colliver et al., Anal. Chem., 69:2225-2231, 1997.
Egholm et al., Nature, 365(6446):566-568, 1993.
Ellington and Szostak, Nature 346:818-822, 1990.
Ellington and Szostak, Nature 355:850-852, 1992.
EP 266 032
Famulok and Szostak, J. Am. Chem. Soc. 114:3990-3991, 1992.
Famulok and Szostak, Angew. Chem. Intl. Ed. Engl. 31:979-988, 1992.
Froehler et al., Nucleic Acids Res., 14(13):5399-5407, 1986.
Gefter et al., Somatic Cell Genet., 3:231-236, 1977.
Goding, In: Monoclonal Antibodies. Principles and Practice, 2d ed., Academic Press, FL., 60-66, and 71-74, 1986.
Guest, Int. J. Mass Spectrom. Ion Process., 60:189-199, 1984.
Gygi et al., Nat. Biotechnol., 17:994-999, 1999.
Han et al., Nat. Biotechnol., 19:946-951, 2001.
Harlow and Lane, In: Antibodies. A Laboratory Manual, Cold Spring Harbor Laboratory, Cold Spring Harbor, N.Y., 346-348, 1988.
Hercules et al., Anal. Chim. Acta., 195:61-71, 1987.
Hillenkamp et al., Nature, 256:119-120, 1975.
Kinsel et al., Anal. Chem., 71:268, 1999.
Kohler and Milstein, Eur. J. Immunol., 6:511-519, 1976.
Kohler and Milstein, Nature, 256:495-497, 1975.
Kornberg and Baker, DNA Replication, 2nd Ed., Freeman, San Francisco, 1992.
Laiko et al., Rapid Commun. Mass Spectrom., 16:1737-1742, 2002.
Lewis et al., Int. J. Mass Spectrom., 226:107-116, 2003.
McMahon. et al., J. Am. Soc. Mass Spectrom., 6:1047-58, 1995.
Olejnik et al., Nucleic Acids Research, 27, 4626-4631, 1999.
Orlando et al., Anal. Chem., 69:4716, 1997.
Pacholski et al., Chem. Rev., 99:2977-3005, 1999.
Patri et al., Bioconjugate Chem. 15:1174-1181, 2004.
PCT Appln. EP/01219
PCT Appln. WO 92/20702
PCT Appln. GB/00/03306
Perreault et al., Anal. Chem., 70:5142, 1998.
Porter et al., J. Amer. Chem. Soc., 111:7616-7618, 1989.
Reyzer et al., J. Mass Spectrom., 38: 1081-1092, 2003.
Rousell et al., J. Mass Spectrom., 39:1182-1189, 2004.
Rudenauer, Anal. Chim. Acta., 297:197-230, 1994.
Russell et al., Int. J. Mass Spectrom., 182/183, 1999.
Sambrook et al., In. Molecular cloning, Cold Spring Harbor Laboratory Press, Cold Spring Harbor, N.Y., 2001.
Seydel et al., J. Microbiol. Methods, 15:167-183, 1992.
Spengler et al., J. Am. Soc. Mass Spectrom., 13:735-748, 2002.
Stetsenko et al., J. Org. Chem., 65:4900-4908, 2000.
Stoeckli et al., Nat. Med., 7:493-6, 2001.
Tanaka et al., Rapid Commun. Mass Spectrom. 2:151, 1988.
Tolstogouzov et al., Mikrochim. Acta., 114:505-510, 1994.
Touboul et al., J. Am. Soc. Mass Spectrom., 16:1608-1618, 2005.
Touboul et al., Anal. Chem., 76:1550-1559, 2004.
Tuerk and Gold, Science 249:505-510, 1990.
Woods et al., Anal. Chem., 70:750, 1998.
Xu et al., Applied Surface Science, 231-2:159-163, 2004a.
Xu et al., J. Am. Chem. Soc. 126:3902-3909, 2004b.
Zhou et al., Nat. Biotechnol., 20:512-515, 2002.

1. A method of obtaining information on multiple distinct target molecules comprising:
a) obtaining a population of mass tagged complexes each of the mass tagged complexes comprising:
i) a distinct mass tag that is detectable by mass spectrometry;
ii) a binding domain with specificity for a distinct target molecule; and
iii) a cleavable linker region between the distinct mass tag and the binding domain;
b) contacting said population with a sample under conditions that allow said binding domain to interact with said target molecules;
c) cleaving the linker region of the mass tagged complexes; and
d) detecting mass tagged complexes in the sample by matrix-free desorption ionization mass spectrometry.

2. The method of claims 1, wherein said population of mass tagged complexes comprises two or more distinct mass tagged complexes.

3. The method of claim 1, wherein the distinct mass tag is a less than about 2000 amu compound resulting from a cleavage reaction.

4. The method of claim 1, wherein the mass tag is positively or negatively charged.

5. The method of claim 4, wherein the charge on the mass tag is carried by a chemical group such as a —P⁺R′₃, —N⁺R′₃, amidino or guanadino group.

6. The method of claim 1, wherein the mass tag comprises an intermediate charge species produced during the cleavage process.

7. The method of claim 1, wherein the distinct mass tag is a polymer.

8. The method of claim 7, wherein the polymer is an amino acid polymer.

9. The method of claim 1, wherein the binding domain is comprised of nucleic acid, amino acid sequence or a ligand.

10. The method of claim 9, wherein the nucleic acid sequence is a nucleic acid aptamer.

11. The method of claim 9, wherein the nucleic acid sequence is an oligonucleotide.

12. The method of claim 11, wherein the oligonucleotide is 8 to 25 nucleotides in length.

13. The method of claim 9, wherein the nucleic acid sequence is an RNA or DNA nucleic acid sequence.

14. The method of claim 9, wherein the amino acid sequence is an antibody domain.

15. The method of claim 14, wherein the antibody domain is an IgG, IgA, IgE, F(ab), F(ab′)₂ or single chain antibody domain.

16. The method of claim 9, wherein the ligand is an amino acid sequence.

17. The method of claim 9, wherein the ligand is a drug or a drug metaboloite.

18. The method of claim 9, wherein the ligand is a lectin.

19. The method of claim 1, wherein the number of mass tags is controlled by a molecular amplification system.

20. The method of claim 19, wherein the molecular amplification system is a dendrimer.

21. The method in claim 20, wherein the dendrimer is a first, second, third, fourth, fifth, sixth, seventh, eighth, ninth or tenth generation dendrimer.

22. The method of claim 1, wherein the cleavable linker is a chemically cleavable linker, enzyme-cleavable linker, a heat cleavable linker or a photo-cleavable linker.

23. The method of claim 22, wherein the cleavable linker comprises an aryl azide, carbodiimide, hydrazine, hydroxymethyl phosphine, imidoester, isocyanate, carbonyl, maleimide, NHS-ester, PFP-ester, psoralen, pyridyl disulfide, vinyl sulfone, benzoin derivatives, arysulfonamide derivatives, thiopixyl derivatives, coumaryl derivatives, nitrobenzyl derivatives, α,α-dimethyl-3,5 dimethyoxybenzyloxycarbonyl derivatives, phenacyl derivatives, arylmethyl derivatives, vinylsilane derivatives or cinnamic acid derivative.

24. The method of claim 23, wherein the photo-cleavable linker is a cinnamic acid derivative.

25. The method of claim 1, wherein obtaining information comprises obtaining spatial information.

26. The method of claim 1, wherein obtaining information comprises obtaining quantitative information.

27. The method of claim 1, wherein obtaining information comprises obtaining quantitative and spatial information.

28. The method of claim 1, wherein the distinct target molecule is a small molecule, RNA, DNA, protein, carbohydrate or lipid molecule.

29. The method of claim 28, wherein the protein is membrane protein.

30. The method of claim 1, wherein the sample is a liquid.

31. The method of claim 30, wherein the liquid is a cell lysate, tissue extract or body fluid.

32. The method of claim 31, wherein the liquid is embedded in a gel substrate.

33. The method of claim 1, wherein the sample is a tissue cross-section.

34. The method of claim 1, wherein the desorption-ionization method is desorption electrospray ionization mass spectrometry (DESI MS), secondary ion mass spectrometry (SIMS), inductively coupled plasma mass spectrometry (ICP MS) or laser desorption/ionization mass spectrometry (LDI MS).

35. The method of claims 34, wherein the desorption-ionization method is laser desorption/ionization mass spectrometry (LDI MS).

36. The method of claim 1, wherein the laser desorption ionization is by a UV or IR laser.

37. The method of claim 36, wherein the laser emits a wave length of about 337, 349 or 355 nm.

38. The method of claim 1, wherein the binding domain from the mass tagged complex interacts directly with the target molecule.

39. The method of claim 1, wherein the binding domain from the mass tagged complex interacts indirectly with the target molecule.

40. The method of claims 1, wherein the binding domain binds to an antibody domain.

41. A method of obtaining information on multiple distinct target molecules comprising:
a) obtaining a population of mass tagged complexes each of the mass tagged complexes comprising:
i) a distinct mass tag that is detectable by mass spectrometry;
ii) a binding domain with specificity for a distinct target molecule; and
iii) a photo-cleavable linker region between the distinct mass tag and the binding domain;
b) contacting said population with a sample under conditions that allow said binding domain to interact with said target molecule; and
c) detecting mass tagged complexes in the sample by matrix-free laser desorption ionization mass spectrometry wherein said laser is capable of cleaving said photo-cleavable linker.

42.-76. (canceled)

77. The method of claim 25, wherein the spatial information has a resolution of between about 0.1 μm and 100 μm.

78. The method of claim 66, wherein the spatial information has a resolution of between about 0.1 μm and 100 μm.

79. The method of claim 63, wherein the photo-cleavable linker is cinnamic acid.

80. The method of claim 70, wherein the liquid is embedded in a gel substrate.
